(19) United States
(12) Patent Application Publication
(10) Pub. No.: US 2026/0059165 A1
(43) Pub. Date: Feb. 26, 2026

(54) ELECTRONIC DEVICE AND OPERATION METHOD THEREOF

(71) Applicant: Samsung Electronics Co., Ltd., Suwon-si (KR)

(72) Inventors: Jongin LEE, Suwon-si (KR); Sehyun KIM, Suwon-si (KR); Donghwa JEONG, Suwon-si (KR); Donguk KIM, Suwon-si (KR); Yeonwoo KIM, Suwon-si (KR)

(73) Assignee: Samsung Electronics Co., Ltd., Suwon-si (KR)

(21) Appl. No.: 19/293,855

(22) Filed: Aug. 7, 2025

Related U.S. Application Data
(63) Continuation of application No. PCT/KR2025/010705, filed on Jul. 21, 2025.

(30) Foreign Application Priority Data
Aug. 23, 2024 (KR) 10-2024-0113742

(51) Int. Cl. H04N 21/431

(52) U.S. Cl. CPC H04N 21/4312

(57) ABSTRACT

An electronic device may include at least one processor, and a memory storing a plurality of instructions. The at least one processor may individually or collectively execute the instructions to cause the electronic device to control provision of a user interface including a plurality of content items, each corresponding to content access information, cause the electronic device to control a visual effect to be applied collectively to an item group including the plurality of content items, when content access information of the plurality of content items are identical to each other. The plurality of instructions, when executed by the at least one processor individually or collectively, cause the electronic device to control the visual effect to be applied individually to the plurality of content items, when the content access information of the plurality of content items are different from each other.

### CROSS REFERENCE TO THE RELATED APPLICATION

This application is a continuation application, filed under 35 U.S.C. § 111 (a), of International Application No. PCT/KR2025/010705, filed on Jul. 21, 2025, and is based on and claims priority under 35 U.S.C. § 119 to Korean Patent Application No. 10-2024-0113742, filed on Aug. 23, 2024 in the Korean Intellectual Property Office, the disclosures of which are incorporated by reference herein in their entireties.

### TECHNICAL FIELD

One or more embodiments of the disclosure relate to display devices and operation methods thereof, and more particularly, to an electronic device that provides content, and an operation method of the electronic device.

### BACKGROUND ART

Recently, in addition to watching real-time broadcast content, viewing Video on Demand (VOD) content via the Internet has become popular. The goal is to provide a user interface (UI) capable of enhancing interactivity with users and allowing users to easily search or access broadcasting content or VOD content.

### DISCLOSURE

### Technical Solution

An electronic device according to an embodiment of the disclosure may include at least one processor including a processing circuit, and a memory storing a plurality of instructions.

The at least one processor individually or collectively may execute the plurality of instructions to cause the electronic device according to an embodiment of the disclosure to control provision of a user interface including a plurality of content items, each corresponding to content access information.

The at least one processor individually or collectively may execute the plurality of instructions to cause the electronic device according to an embodiment of the disclosure to control a visual effect to be applied collectively to an item group including the plurality of content items to enable the plurality of content items to be collectively selectable, based on pieces of the content access information of the plurality of content items being identical to each other.

The at least one processor individually or collectively may execute the plurality of instructions to cause the electronic device according to an embodiment of the disclosure to control the visual effect to be applied individually to the plurality of content items, respectively, to enable the plurality of content items to be individually selectable, based on the pieces of the content access information of the plurality of content items being different from each other.

A method of operating an electronic device according to an embodiment of the disclosure may include an operation of controlling provision of a user interface including a plurality of content items, each corresponding to each content access information.

The method of operating an electronic device according to an embodiment of the disclosure may include an operation of controlling a visual effect to be applied collectively to an item group including the plurality of content items to enable the plurality of content items to be collectively selectable, based on pieces of the content access information of the plurality of content items being identical to each other.

The method of operating an electronic device according to an embodiment of the disclosure may include an operation of controlling the visual effect to be applied individually to the plurality of content items, respectively, to enable the plurality of content items to be individually selectable, based on the pieces of the content access information of the plurality of content items being different from each other.

### DESCRIPTION OF DRAWINGS

The disclosure may be readily understood by reference to the following detailed description and the accompanying drawings, in which reference numerals refer to structural elements.

FIG. 1A illustrates an example of a system including an electronic device, a server device, and a control device according to an embodiment of the disclosure.

FIG. 1B illustrates an example of a system including an electronic device, a server device, and a display device according to an embodiment of the disclosure.

FIG. 2 is a block diagram of an electronic device according to an embodiment of the disclosure.

FIG. 3 is a flowchart of an operation method of an electronic device, according to an embodiment of the disclosure.

FIG. 4A is a flowchart of a method, performed by an electronic device, of receiving metadata regarding a content item from a server device, according to an embodiment of the disclosure.

FIGS. 4B and 4C illustrate examples of grouping-related information according to an embodiment of the disclosure.

FIG. 5 illustrates a user interface screen image of an electronic device, according to an embodiment of the disclosure.

FIGS. 6A through 6C illustrate examples of a user interface according to an embodiment of the disclosure.

FIGS. 7A and 7B illustrate examples of an item group displayed within a user interface, according to an embodiment of the disclosure.

FIG. 8 is a flowchart of a method, performed by an electronic device, of displaying a visual effect, according to an embodiment of the disclosure.

FIGS. 9A through 9D are reference diagrams for explaining a method of displaying a focus on an item group, according to an embodiment of the disclosure.

FIG. 10 is a flowchart of a method, performed by an electronic device, of controlling display of an item group when moving a visual effect, according to an embodiment of the disclosure.

FIGS. 11A through 11C are reference diagrams for explaining a method of displaying an item group when a focus moves from the item group to an adjacent next content item, according to an embodiment of the disclosure.

FIG. 12 is a flowchart of a method, performed by an electronic device, of controlling display of an item group when moving a visual effect, according to an embodiment of the disclosure.

FIG. 13 is a reference diagram for explaining a method of displaying a focus on an item group, according to an embodiment of the disclosure.

FIGS. 14A and 14B are reference diagrams for explaining a method of displaying text regarding an item group when moving a focus, according to an embodiment of the disclosure.

FIG. 15 is a reference diagram for explaining a method of displaying an item group when moving a focus, according to an embodiment of the disclosure.

FIG. 16 is a reference diagram for explaining a method of displaying an item group when moving a focus, according to an embodiment of the disclosure.

FIG. 17 illustrates an example of an item group displayed within a user interface, according to an embodiment of the disclosure.

FIGS. 18A and 18B illustrate examples of an item group displayed within a user interface, according to an embodiment of the disclosure.

FIG. 19 illustrates an example of an item group displayed within a user interface, according to an embodiment of the disclosure.

FIG. 20 is a flowchart of a method, performed by an electronic device, of receiving metadata regarding a content item from a server device, according to an embodiment of the disclosure.

### MODE FOR INVENTION

Terms used herein will be described briefly, and the present disclosure will be described in detail.

Although general terms widely used at present were selected for describing the present disclosure in consideration of the functions thereof, these general terms may vary according to intentions of one of ordinary skill in the art, case precedents, the advent of new technologies, or the like. Terms arbitrarily selected by the applicant of the disclosure may also be used in a specific case. In this case, their meanings need to be given in the detailed description of the disclosure. Hence, the terms must be defined based on their meanings and the contents of the entire specification, not by simply stating the terms.

The terms “comprises” and/or “comprising” or “includes” and/or “including” when used in this specification, specify the presence of stated elements, but do not preclude the presence or addition of one or more other elements. The terms “unit”, “-er (-or)”, and “module” when used in this specification refers to a unit in which at least one function or operation is performed, and may be implemented as hardware, software, or a combination of hardware and software.

The present disclosure will now be described more fully with reference to the accompanying drawings, in which exemplary embodiments of the present disclosure are shown. The present disclosure may, however, be embodied in many different forms and should not be construed as being limited to the embodiments of the disclosure set forth herein. In the drawings, parts irrelevant to the description are omitted for the simplicity of explanation, and like numbers refer to like elements throughout.

Functions related to AI according to the disclosure are operated through a processor and a memory. The processor may include one or a plurality of processors. The one or plurality of processors may be a general-purpose processor such as a central processing unit (CPU), an application processor (AP), or a digital signal processor (DSP), a graphics-only processor such as a graphics processing unit (GPU) or a vision processing unit (VPU), or an AI-only processor such as a neural processing unit (NPU). The one or plurality of processors control to process input data, according to a predefined operation rule or AI model stored in the memory. Alternatively, when the one or plurality of processors are AI-only processors, the AI-only processors may be designed in a hardware structure specialized for processing a specific AI model.

The AI may include a machine learning (deep learning) technology of using an algorithm that classifies/learns the features of pieces of input data by itself, and element technologies of mimicking functions, such as recognition and determination by human brains, by utilizing a machine learning algorithm. For example, the element technologies may include at least one of linguistic understanding technology that recognizes human language/text, visual understanding technology that recognizes objects like human vision, deduction/prediction that logically performs deduction and prediction by determining information, knowledge representation that processes human experience information as knowledge data, vehicle's autonomous traveling, or operation control for controlling a motion of a robot. Linguistic understanding is a technique of recognizing a language/character of a human and applying/processing the language/character of a human, and may include natural language processing, machine translation, a conversation system, questions and answers, voice recognition/synthesis, and the like. Visual understanding is a technique of recognizing and processing an object like in human vision, and may include object recognition, object tracking, image search, human recognition, scene understanding, space understanding, image improvement, and the like. Deduction/prediction is a technology of logically performing deduction and prediction by determining information, and may include knowledge/probability-based deduction, optimization prediction, a preference-based plan, recommendation, and the like. Knowledge representation is a technique of automatically processing human experience information as knowledge data, and may include knowledge establishment (data generation/classification), knowledge management (data utilization), and the like.

The predefined operation rule or AI model is characterized in that it is created through learning. Here, being created through learning means that a basic AI model is trained using a plurality of training data by a learning algorithm, so that a predefined operation rule or AI model set to perform desired characteristics (or a desired purpose) is created. Such learning may be performed in a device itself on which AI according to the disclosure is performed, or may be performed through a separate server and/or system. Examples of the learning algorithm include, but are not limited to, supervised learning, unsupervised learning, semi-supervised learning, or reinforcement learning.

The AI model may be composed of a plurality of neural network layers. Each of the plurality of neural network layers has a plurality of weight values, and performs a neural network operation through an operation between an operation result of a previous layer and the plurality of weight values. The plurality of weight values of the plurality of neural network layers may be optimized by a learning result of the AI model. For example, the plurality of weight values may be updated so that a loss value or a cost value obtained from the AI model is reduced or minimized during a learning process. An artificial neural network may include a deep neural network (DNN), for example, a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), or a Deep Q-Networks, but embodiments of the disclosure are not limited thereto.

The term “user” used herein denotes a person who controls a function or operation of a computing device or an electronic device by using a control device. Examples of the user may include a viewer, a manager, or an installation engineer.

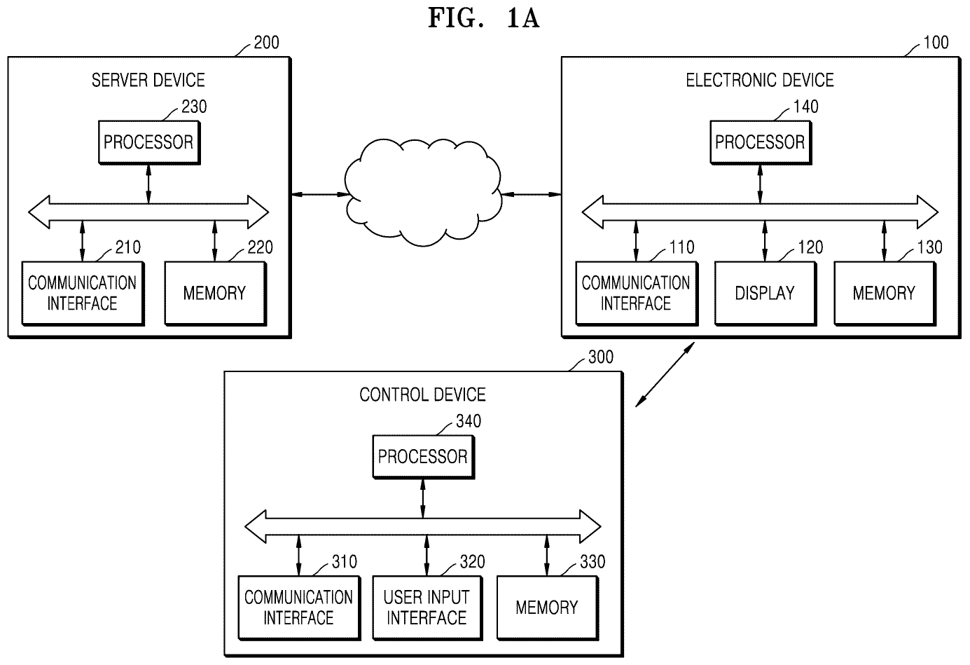

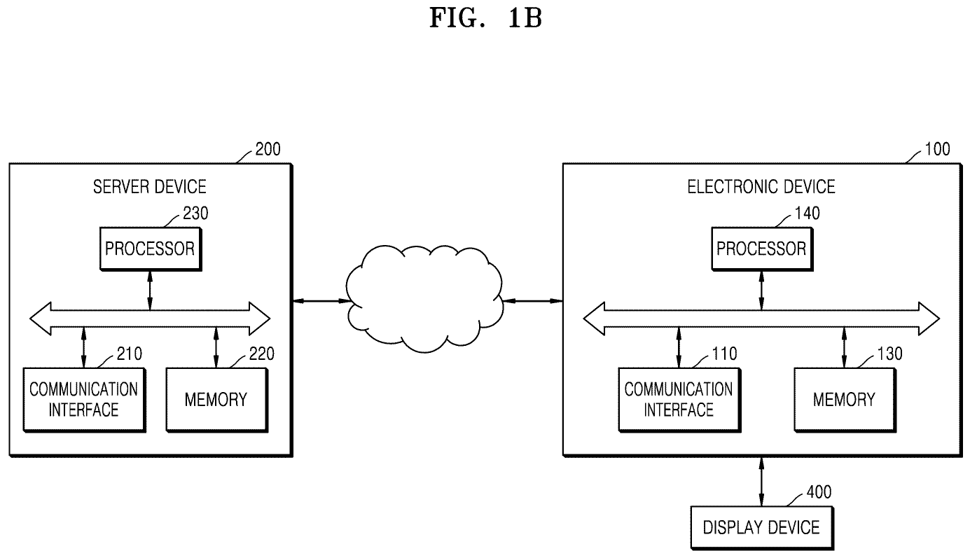

FIG. 1A illustrates an example of a system including an electronic device, a server device, and a control device according to an embodiment of the disclosure. FIG. 1B illustrates an example of a system including an electronic device, a server device, and a display device according to an embodiment of the disclosure.

Referring to FIG. 1A, a server device 200 may receive a content request from an electronic device 100, and may transmit requested content to the electronic device 100 via a communication network. The electronic device 100 may transmit the content request to the server device 200, receive the requested content from the server device 200, and display the received content on a display of the electronic device 100.

According to an embodiment of the disclosure, the server device 200 may receive a request of a content item from the electronic device 100, and may transmit the requested content item to the electronic device 100. The electronic device 100 may transmit the content item request to the server device 200, receive the requested content item from the server device 200, and display a user interface on the display of the electronic device 100, based on the received content item.

The content item may refer to an object provided to the user interface in order to enable execution or display of content corresponding to the content item according to selection of the content item. The content item may be displayed as a thumbnail image representing content corresponding to the content item, and may be mapped with address information, etc. for obtaining the corresponding content may be mapped to the content item. The address information for obtaining content may be now referred to as content access information.

Typically, content providers may provide content items corresponding to their pieces of content in order to provide the pieces of content. The content providers may map and provide one content item for one piece of content. Alternatively, the content providers may provide a plurality of content items for a single piece of content or a plurality of content items for related content, such as a series, in order to highlight certain content and provide an effective experience.

The electronic device 100 according to an embodiment of the disclosure may provide a method in which the electronic device 100 is able to effectively display and control the plurality of content items provided for the same content by using an item group.

The electronic device 100 according to an embodiment of the disclosure may provide a method in which the electronic device 100 is able to effectively display and control the plurality of content items provided for the related content by using the item group.

The electronic device 100 according to an embodiment of the disclosure may provide a method in which the electronic device 100 is able to effectively display and control, by using the item group, the plurality of content items corresponding to the same content or related content provided by a plurality of different content providers.

According to an embodiment of the disclosure, the system may include the electronic device 100, the server device 200, and a control device 300 connected to one another via a communication network.

The electronic device 100 is capable of displaying an image or data according to a user's request, and may include a communication interface 110, a display 120, a memory 130, and a processor 140.

The communication interface 110 may include one or more modules that enable wireless communication between the electronic device 100 and a wireless communication system or between the electronic device 100 and a network in which another device is located. According to an embodiment of the disclosure, the communication interface 110 may communicate with the control device 300 according to short-range communication technology. Examples of the short-range communication technology may include Bluetooth communication, Wi-Fi communication, and infrared communication. According to an embodiment of the disclosure, the communication interface 310 may communicate with the server device 200 according to an Internet protocol.

The display 120 may output an image or data processed by the electronic device 100.

The memory 130 may store a program used by the processor 140 to perform processing and control, and may also store data that is input to or output from the electronic device 100. The memory 130 may also store pieces of data necessary for an operation of the electronic device 100.

The memory 130 may include at least one type of storage medium from among a flash memory type storage medium, a hard disk type storage medium, a multimedia card micro type storage medium, a card type memory (for example, SD or XD memory), a random access memory (RAM), a static RAM (SRAM), a read-only memory (ROM), an electrically erasable programmable ROM (EEPROM), a programmable ROM (PROM), a magnetic memory, a magnetic disk, and an optical disk.

The processor 140 controls an overall operation of the electronic device 100. For example, the processor 140 may perform a function of the electronic device 100 according to the disclosure, by executing one or more instructions stored in the memory 130.

According to an embodiment of the disclosure, the processor 140 may store one or more instructions in an internal memory, and may control operations of the electronic device 100 to be performed, by executing the one or more instructions stored in the internal memory. In other words, the processor 140 may perform a predetermined operation by executing at least one instruction or program stored in the internal memory or the memory 130.

The processor 140 may include various processing circuits and/or a plurality of processors. For example, the term “processor” used herein, and also in the claims, may include various processing circuits, including at least one processor. One or more processors in the at least one processor may be configured to individually and/or collectively perform the various functions described herein, in a distributed manner. As used herein, “a processor”, “at least one processor”, and “one or more processors” may be configured to perform several functions. However, these terms cover, for example, but not limited to, a situation where one processor performs some of the functions and other processor(s) perform others of the functions, and a situation where a single processor is capable of performing all of the functions. In addition, the at least one processor may include a combination of processors that perform various functions of the functions disclosed in a distributed manner. The at least one processor may execute program instructions in order to accomplish or perform various functions.

According to an embodiment of the disclosure, the processor 140 may perform an operation of the electronic device 100, by executing the one or more instructions stored in the memory 130.

The plurality of instructions, when executed by the at least one processor individually or collectively, may cause (or the at least one processor may individually or collectively execute the plurality of instructions to cause) the electronic device according to an embodiment of the disclosure to control provision of a user interface including a plurality of content items, each corresponding to each content access information.

The plurality of instructions, when executed by the at least one processor individually or collectively, may cause the electronic device according to an embodiment of the disclosure to control application of a visual effect to an item group including the plurality of content items, when the pieces of content access information of the plurality of content items are identical to each other. The electronic device 100 may control a visual effect to be applied collectively to an item group including the plurality of content items to enable the plurality of content items to be collectively selectable, based on pieces of the content access information of the plurality of content items being identical to each other.

The plurality of instructions, when executed by the at least one processor individually or collectively, may cause the electronic device according to an embodiment of the disclosure to control application of the visual effect to each of the plurality of content items, when the pieces of content access information of the plurality of content items are different from each other. The electronic device 100 may control the visual effect to be applied individually to the plurality of content items, respectively, to enable the plurality of content items to be individually selectable, based on the pieces of the content access information of the plurality of content items being different from each other.

According to an embodiment of the disclosure, the plurality of content items included in the user interface may correspond to a plurality of different servers providing the same content, respectively.

The plurality of instructions, when executed by the at least one processor individually or collectively, may cause the electronic device according to an embodiment of the disclosure, in response to a user input corresponding to selection of one of the plurality of content items included in the user interface, to control the communication interface 110 to receive content corresponding to a content item based on the user input from a server corresponding to the content item based on the user input.

The plurality of instructions, when executed by the at least one processor individually or collectively, may cause the electronic device according to an embodiment of the disclosure to control provision of the user interface in which the plurality of content items are arranged, based on accessibility information for the plurality of different servers.

According to an embodiment of the disclosure, the accessibility information may include at least one of whether an account of a service provided by each of the plurality of different servers is logged in, whether the service is subscribed, or the frequency of use of the service.

The plurality of instructions, when executed by the at least one processor individually or collectively, may cause the electronic device according to an embodiment of the disclosure to control provision of the user interface on which the plurality of content items are displayed as a single thumbnail image. According to an embodiment of the disclosure, the single thumbnail image may correspond to any one of a pre-determined image, an image automatically generated based on artificial intelligence (AI), or an image received from any one of the plurality of different servers.

The plurality of instructions, when executed by the at least one processor individually or collectively, may cause the electronic device according to an embodiment of the disclosure to control the communication interface 110 to receive grouping-related information from a server that provides content corresponding to the plurality of content items. According to an embodiment of the disclosure, the grouping-related information may include at least one of an arrangement order of the plurality of content items constituting the item group, whether the plurality of content items are displayable independently, or whether the plurality of content items are changeable into a single content item.

The plurality of instructions, when executed by the at least one processor individually or collectively, may cause the electronic device according to an embodiment of the disclosure, in response to a user input corresponding to movement of the visual effect guiding that a content item is selectable, to control display of the item group, based on at least one of whether the plurality of content items constituting the item group are independently displayable or whether the plurality of content items are changeable into a single content item.

When independent display of the plurality of content items is impossible (or unsupported) and change of the plurality of content items into a single content item is possible, the plurality of instructions, when executed by the at least one processor individually or collectively, may cause the electronic device according to an embodiment of the disclosure, in response to a user input of moving the visual effect from the item group to an adjacent content item, to change the plurality of content items constituting the item group into the single content item (or a single thumbnail item). Based on independent display of the plurality of content items being unsupported and change of the plurality of content items into a single content item being enabled, the at least one processor individually or collectively may execute the instructions to cause the electronic device to change the plurality of content items constituting the item group into the single content item, in response to a user input of moving the visual effect from the item group to an adjacent content item.

When independent display of the plurality of content items is impossible (or unsupported) and change of the plurality of content items into a single thumbnail item is impossible, the plurality of instructions, when executed by the at least one processor individually or collectively, may cause the electronic device according to an embodiment of the disclosure, in response to a user input of moving the visual effect from the item group to an adjacent content item, to control the item group to entirely disappear or may change the plurality of content items into the single content item (or the single thumbnail item) displayed as a thumbnail image related to the item group. Based on independent display of the plurality of content items being unsupported and the plurality of content items into a single thumbnail item being unchangeable, the at least one processor individually or collectively may execute the instructions to cause the electronic device to to control the item group to one of disappear or change the plurality of content items into the single content item displayed as a thumbnail image related to the item group, in response to a user input of moving the visual effect from the item group to an adjacent content item

The plurality of instructions, when executed by the at least one processor individually or collectively, may cause the electronic device according to an embodiment of the disclosure to control display of the plurality of content items constituting the item group by overlapping, when the visual effect is applied to other content items other than the item group. The at least one processor individually or collectively may execute the instructions to cause the electronic device to control the plurality of content items constituting the item group to overlap each other and be displayed, based on the visual effect being applied to content items other than the item group.

The plurality of instructions, when executed by the at least one processor individually or collectively, may cause the electronic device according to an embodiment of the disclosure to control display of the plurality of content items constituting the item group to be displayed without overlapping each other (or in an expanded manner), when the visual effect is applied to one of the plurality of content items constituting the item group. The at least one processor individually or collectively may execute the instructions to cause the electronic device to control the plurality of content items constituting the item group to be displayed without overlapping each other, based on the visual effect being applied to one of the plurality of content items constituting the item group.

The plurality of instructions, when executed by the at least one processor individually or collectively, may cause the electronic device according to an embodiment of the disclosure, in response to a user input corresponding to movement of the visual effect guiding that a content item is a selectable, to change at least one of display of an image displaying the plurality of content items or a display of text regarding the item group.

The electronic device 100 may be any type of device that performs a function by including a processor and a memory. The electronic device 100 may be a fixed or portable device. For example, the electronic device 100 may represent a device capable of displaying image content, video content, game content, graphic content, and the like by including a display. The electronic device 100 may output or display an image or content received from the server device 200. The electronic device 100 may include various types of electronic devices capable of receiving and outputting content, such as televisions (TV) (such as, a network TV, a smart TV, an Internet TV, a web TV, and an IPTV), computers (such as, a desktop, a laptop, and a tablet), and various smart devices (such as, a smartphone, a cellular phone, a game player, a music player, a video player, medical equipment, and a home appliance). The electronic device 100 may be referred to as a display apparatus in terms of receiving and displaying content, and may also be referred to as a content receiving device, a sync device, a computing device, or the like.

The block diagram of the electronic device 100 illustrated in FIG. 1A is for an embodiment. Components illustrated in the block diagram of FIG. 1A may be combined or omitted according to the specifications of the electronic device 100 when being actually implemented, or additional components may be included in the block diagram of FIG. 1A. For example, according to need, two or more components are combined into a single component, or a single component may be divided into two or more components. A function performed in each block is merely an example to explain embodiments, and a detailed operation or device of each block does not limit the scope of the embodiments.

The server device 200 may include a communication interface 210, a memory 220, and a processor 230. However, the server device 200 may be implemented by more or less components than the components illustrated in FIG. 1A. For example, the server device 200 may include a separate image processor for image processing of content provided by the server device 200.

The communication interface 210 may include one or more modules that enable wireless communication between the server device 200 and a wireless communication system or between the server device 200 and a network in which another device is located. According to an embodiment of the disclosure, the communication interface 210 may communicate with the electronic device 100 according to an Internet protocol. According to an embodiment of the disclosure, the communication interface 210 may communicate with the control device 300 according to an Internet protocol.

The memory 220 may store a program used by the processor 230 to perform processing and control, and may also store data that is input to or output from the server device 200.

The memory 220 may include at least one type of storage medium from among a flash memory type storage medium, a hard disk type storage medium, a multimedia card micro type storage medium, a card type memory (for example, SD or XD memory), a random access memory (RAM), a static RAM (SRAM), a read-only memory (ROM), an electrically erasable programmable ROM (EEPROM), a programmable ROM (PROM), a magnetic memory, a magnetic disk, and an optical disk.

The processor 230 controls the overall operation of the server device 200. For example, the processor 230 may perform a function of the server device 200 according to the disclosure by executing one or more instructions stored in the memory 220.

According to an embodiment of the disclosure, the processor 230 may store one or more instructions in an internal memory, and may control the above-described operations to be performed, by executing the one or more instructions stored in the internal memory. In other words, the processor 230 may perform a predetermined operation by executing at least one instruction or program stored in an internal memory included in the processor 230 or the memory 220.

The processor 230 may include various processing circuits and/or a plurality of processors. For example, the term “processor” used herein, and also in the claims, may include various processing circuits, including at least one processor. One or more processors in the at least one processor may be configured to individually and/or collectively perform the various functions described herein, in a distributed manner. As used herein, “a processor”, “at least one processor”, and “one or more processors” may be configured to perform several functions. However, these terms cover, for example, but not limited to, a situation where one processor performs some of the functions and other processor(s) perform others of the functions, and a situation where a single processor is capable of performing all of the functions. In addition, the at least one processor may include a combination of processors that perform various functions of the functions disclosed in a distributed manner. The at least one processor may execute program instructions in order to accomplish or perform various functions.

According to an embodiment of the disclosure, the processor 230 may receive a content request from the electronic device 100 and transmit requested content to the electronic device 100, by executing the one or more instructions stored in the memory 220.

According to an embodiment of the disclosure, the processor 230 may generate and transmit metadata according to a format requested by the electronic device 100 when transmitting metadata regarding a content item, by executing the one or more instructions stored in the memory 220.

According to an embodiment of the disclosure, the metadata may include an image for displaying content items, and content access information to be linked through the content items. According to an embodiment of the disclosure, the metadata may include grouping-related information for displaying and controlling an item group including a plurality of content items capable of providing pieces of content associated with each other.

The server device 200 may include the communication interface 210, the memory 220, and the processor 230. However, the server device 200 may be implemented by more or less components than the components illustrated in FIG. 1A. For example, the server device 200 may include a separate image processor for image processing of an application image executed by the server device 200.

The block diagram of the server device 200 illustrated in FIG. 1A is for an embodiment. Components illustrated in FIG. 1A may be combined or omitted according to the specifications of the server device 200 when being actually implemented, or additional components may be included in the block diagram of FIG. 1A. For example, according to need, two or more components are combined into a single component, or a single component may be divided into two or more components. A function performed in each block is merely an example to explain embodiments, and a detailed operation or device of each block does not limit the scope of the embodiments.

The control device 300 may represent an input device for controlling an operation of the electronic device 100.

The control device 300 may include a communication interface 310, a user input interface 320, a memory 330, and a processor 340. However, the control device 300 may be implemented by more or less components than the components illustrated in FIG. 1A.

The communication interface 310 may include one or more modules that enable wireless communication between the control device 300 and a wireless communication system or between the control device 300 and a network in which another device is located. According to an embodiment of the disclosure, the communication interface 310 may communicate with the electronic device 100 according to short-range communication technology. Examples of the short-range communication technology may include Bluetooth communication, Wi-Fi communication, infrared communication, etc. According to an embodiment of the disclosure, the communication interface 310 may communicate with the server device 200 according to an Internet protocol.

The user input interface 320 may be any type of interface means capable of receiving a user input. For example, the user input interface 320 may be arranged in a portion of the control device 300 and may include an operation button capable of receiving a user input, a touch-sensitive display configured to detect a touch input, and a microphone capable of receiving a user's voice speech input. According to an embodiment of the disclosure, when a user's analog voice signal is received via a microphone through the user input interface 320, the control device 300 may digitize the analog voice signal and transmit a result of the digitization to the electronic device 100. At this time, data transmission communications, such as Bluetooth or Wi-Fi, may be used.

The memory 330 may store a program used by the processor 140 to perform processing and control, and may also store data that is input to or output from the control device 300.

The memory 330 may include at least one type of storage medium from among a flash memory type storage medium, a hard disk type storage medium, a multimedia card micro type storage medium, a card type memory (for example, SD or XD memory), a random access memory (RAM), a static RAM (SRAM), a read-only memory (ROM), an electrically erasable programmable ROM (EEPROM), a programmable ROM (PROM), a magnetic memory, a magnetic disk, and an optical disk.

The processor 340 controls an overall operation of the control device 300. For example, the processor 340 may perform a function of the control device 300 by executing the one or more instructions stored in the memory 330.

According to an embodiment of the disclosure, the processor 340 may store one or more instructions in an internal memory, and may control the above-described operations to be performed, by executing the one or more instructions stored in the internal memory. In other words, the processor 340 may perform a predetermined operation by executing at least one instruction or program stored in an internal memory included in the processor 340 or in the memory 330.

The processor 340 may include various processing circuits and/or a plurality of processors. For example, the term “processor” used herein, and also in the claims, may include various processing circuits, including at least one processor. One or more processors in the at least one processor may be configured to individually and/or collectively perform the various functions described herein, in a distributed manner. As used herein, “a processor”, “at least one processor”, and “one or more processors” may be configured to perform several functions. However, these terms cover, for example, but not limited to, a situation where one processor performs some of the functions and other processor(s) perform others of the functions, and a situation where a single processor is capable of performing all of the functions. In addition, the at least one processor may include a combination of processors that perform various functions of the functions disclosed in a distributed manner. The at least one processor may execute program instructions in order to accomplish or perform various functions.

According to an embodiment of the disclosure, the processor 340 may perform a communication connection with the electronic device 100 by using short-range wireless communication technology, by executing the one or more instructions stored in the memory 330. Examples of the short-range wireless communication technology may include Bluetooth communication technology or Wi-Fi direct technology.

The control device 300 may be any type of device that performs a function by including a processor and a memory. The control device 300 may include various electronic devices, such as a remote control device, a smartphone, an AI speaker, and a game control device. For example, by installing a remote control application in a terminal, such as a smartphone, a control function, a voice recognition function, etc. of an electronic device may be performed through the installed remote control application. For example, by installing an application that provides a control function, the control device 300 may include a device that may operate through the installed application.

The block diagram of the control device 300 illustrated in FIG. 1A is for an embodiment. Components illustrated in FIG. 1A may be combined or omitted according to the specifications of the control device 300 when being actually implemented, or additional components may be included in the block diagram of FIG. 1A. For example, according to need, two or more components are combined into a single component, or a single component may be divided into two or more components. A function performed in each block is merely an example to explain embodiments, and a detailed operation or device of each block does not limit the scope of the embodiments.

According to an embodiment of the disclosure, the control device 300 may be omitted. According to an embodiment of the disclosure, the electronic device 100 may include a user input interface, and a user input interface included in the electronic device 100 may be any type of interface means capable of receiving a user input. For example, the user input interface included in the electronic device 100 may be arranged in a portion of the electronic device 100, and may include an operation button capable of receiving a user input, a touch-sensitive display configured to detect a touch input, and a microphone capable of receiving a user's voice speech input.

Referring to FIG. 1B, a system according to an embodiment may include an electronic device 100, a server device 200, and a display device 400 connected to one another via a communication network. The display device 400 may be referred to as an external electronic device.

According to an embodiment of the disclosure, the electronic device 100 may include a communication interface 110, a memory 130, and a processor 140. The electronic device 100 may not include a display. The electronic device 100 may be connected to the display device 400 by wire or wirelessly.

The server device 200 may execute a content application in response to a request from the electronic device 100, and may transmit a result screen image according to execution of the content application to the electronic device 100 via a communication network. The electronic device 100 may transmit a content request to the server device 200, and receive requested content from the server device 200 according to the content request. The electronic device 100 may transmit the received content to the display device 400 via a communication network, and the display device 400 may display the received content.

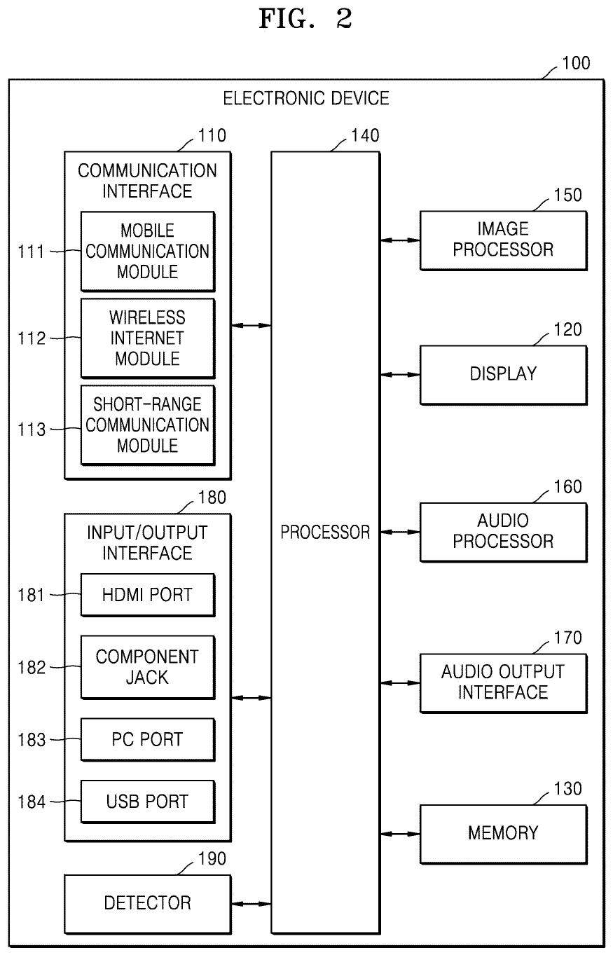

FIG. 2 is a block diagram of the electronic device 100 according to an embodiment.

Referring to FIG. 2, the electronic device 100 may include an image processor 150, an audio processor 160, an audio output interface 170, an input/output interface 180, and a detector 190, in addition to the communication interface 110, the display 120, the memory 130, and the processor 140.

The communication interface 110 may include one or more modules that enable wireless communication between the electronic device 100 and a wireless communication system or between the electronic device 100 and a network in which another electronic device is located. For example, the communication interface 110 may include a mobile communication module 111, a wireless Internet module 112, and a short-range communication module 113.

The mobile communication module 111 transmits or receives a wireless signal to or from at least one of a base station, an external terminal, or a server on a mobile communication network. Examples of the wireless signal may include a voice call signal, a video call signal, or various types of data according to text/multimedia message exchange.

The wireless Internet module 112 is referred to as a module for wireless Internet access, and may be embedded inside or provided outside the electronic device 100. Wireless LAN (WLAN) (WiFi), wireless broadband (Wibro), World Interoperability for Microwave Access (Wimax), High Speed Downlink Packet Access (HSDPA), etc. may be used a wireless Internet technology. Through the wireless Internet module 122, the electronic device 100 may perform a Wi-Fi Peer to Peer (P2P) connection with another device.

The short-range communication module 113 denotes a module for short-distance communication. Bluetooth, Bluetooth Low Energy (BLE), Radio Frequency Identification (RFID), Infrared Data Association (IrDA), Ultra Wideband (UWB), ZigBee, etc. may be used as short-distance communication technology.

According to an embodiment of the disclosure, a module of the communication interface 110 that communicates with the server device 200 and a module of the communication interface 110 that communicates with the control device 300 may be different from each other. For example, the module of the communication interface 110 that communicates with the server device 200 may be an Ethernet modem or a Wi-Fi module, and the module of the communication interface 110 that communicates with the control device 300 may be a Bluetooth module. According to an embodiment of the disclosure, the module of the communication interface 110 that communicates with the server device 200 and the module of the communication interface 110 that communicates with the control device 300 may be the same as each other. For example, the module of the communication interface 110 that communicates with the server device 200 and the module of the communication interface 110 that communicates with the control device 300 may be both Wi-Fi modules.

The display 120 may display, on a screen, an image signal received from the server device 200.

The memory 130 may store a program related to an operation of the electronic device 100 and various pieces of data generated during the operation of the electronic device 100.

The memory 130 may store at least one instruction. The memory 130 may store at least one instruction that the processor 140 executes. The memory 130 may store at least one program that the processor 140 executes. The memory 130 may store an application for providing a predetermined service.

In detail, the memory 130 may include at least one type of storage medium from among a flash memory type storage medium, a hard disk type storage medium, a multimedia card micro type storage medium, a card type memory (for example, SD or XD memory), a random access memory (RAM), a static RAM (SRAM), a read-only memory (ROM), an electrically erasable programmable ROM (EEPROM), a programmable ROM (PROM), a magnetic memory, a magnetic disk, and an optical disk.

The processor 140 controls an overall operation of the electronic device 100. For example, the processor 140 may perform a function of the electronic device 100 according to the disclosure, by executing one or more instructions stored in the memory 130.

According to an embodiment of the disclosure, the processor 140 may store one or more instructions in an internal memory, and may control operations of the electronic device 100 to be performed, by executing the one or more instructions stored in the internal memory. In other words, the processor 140 may perform a predetermined operation by executing at least one instruction or program stored in the internal memory included in the processor 140 or in the memory 130.

The plurality of instructions, when executed by the at least one processor individually or collectively, may cause the electronic device according to an embodiment of the disclosure to provide a user interface for displaying an item group including a plurality of content items that enable provision of pieces of content related to each other, wherein the plurality of content items may respectively correspond to the same content access information or different pieces of content access information used to provide the pieces of content related to each other.

The plurality of instructions, when executed by the at least one processor individually or collectively, may cause the electronic device according to an embodiment of the disclosure to display a focus on the item group, and may apply a visual effect to the item group including the plurality of content items or to each of the plurality of content items included in the item group, based on whether content access information of the plurality of content items respectively corresponding to the plurality of content items are identical to each other.

According to the electronic device 100 according to an embodiment of the disclosure, the plurality of content items may correspond to a plurality of content providing servers providing the same content, respectively, so as to enable connection to different content providing servers in order to provide the same content.

The plurality of instructions, when executed by the at least one processor individually or collectively, may cause the electronic device according to an embodiment of the disclosure, in response to an input corresponding to selection of one of the plurality of content items displayed on a user interface, to receive content corresponding to the selected content item from a content providing server corresponding to the selected content item.

The plurality of instructions, when executed by the at least one processor individually or collectively, may cause the electronic device according to an embodiment of the disclosure to independently display a visual effect on each of the plurality of content items, when content access information corresponding to the plurality of content items are different from each other.

The plurality of instructions, when executed by the at least one processor individually or collectively, may cause the electronic device according to an embodiment of the disclosure to display the visual effect on the entire item group, when the content access information corresponding to the plurality of content items are the same as each other.

The plurality of instructions, when executed by the at least one processor individually or collectively, may cause the electronic device according to an embodiment of the disclosure to control display of the item group, based on at least one of whether the plurality of content items constituting the item group are independently displayable or whether the plurality of content items are changeable into a single content item, when the visual effect guiding that a content item is selectable is displayed according to an input corresponding to movement of the visual effect.

The input/output interface 180 may receive video (for example, a moving picture), audio (for example, a voice or music), and additional information (for example, an EPG) from outside the electronic device 100 under the control by the processor 140, or may transmit video (for example, a moving picture) and audio (for example, a voice or music) signals to an external display or speaker, for example. The input/output interface 180 may include a High-Definition Multimedia Interface (HDMI) port 181, a component jack 182, a personal computer (PC) port 183, or a universal serial bus (USB) port 184, or may include a combination of one or more of the aforementioned ports. The input/output interface 180 may further include a DisplayPort (DP), a Thunderbolt, and a Mobile High-Definition Link (MHL) in addition to the HDMI port. According to an embodiment of the disclosure, the input/output interface 180 may include ports capable of separately outputting a video signal and an audio signal.

The image processor 150 may process an image signal received from the input/output interface 180 or the communication interface 110 and output a processed image signal to the display 120, under a control by the processor 140.

The audio processor 160 may convert an audio signal received from the input/output interface 180 or the communication interface 110 into an analog audio signal and output the analog audio signal to the audio output interface 170, under the control by the processor 140.

The audio output interface 170 may output audio (for example, a voice or a sound) that is input via the communication interface 110 or the input/output interface 180. The audio output interface 170 may also output audio stored in the memory 130 under a control by the processor 140. The audio output interface 170 may include at least one of a speaker, a headphone output port, or a Sony/Philips Digital Interface (S/PDIF) output port, or a combination thereof.

The detector 190 may detect a voice of a user, an image of the user, or an interaction of the user, and may include a microphone, a camera, and a light receiver.

The microphone receives an uttered voice of the user. The microphone may transform the received voice into an electrical signal and output the electrical signal to the processor 140. The user's voice may include, for example, a voice corresponding to a menu or function of the electronic device 100.

The camera may receive an image (for example, consecutive frames) corresponding to a motion of the user including a gesture within a recognition range of the camera. The processor 140 may select a menu that is displayed on the electronic device 100 by using a result of the recognition of the received motion, or perform control corresponding to the result of the recognition of the received motion.

The light receiver receives an optical signal (including a control signal) from the external control device 300 The light receiver may receive an optical signal corresponding to a user input (for example, touch, pressing, a touch gesture, a voice, or a motion) from the control device 300. A control signal may be extracted from the received optical signal under the control by the processor 140.

The processor 140 controls an overall operation of the electronic device 100 and signal flow between internal components of the electronic device 100, and processes data. When there is an input of the user or stored preset conditions are satisfied, the processor 140 may execute an operating system (OS) and various applications that are stored in the memory 130.

The processor 140 may include a graphics processing unit (GPU) (not shown) for performing graphics processing corresponding to a video. The GPU generates a screen image including various objects, such as an icon, an image, and a text, by using an arithmetic unit (not shown) and a rendering unit (not shown). The arithmetic unit calculates attribute values, such as a coordinate value, a shape, a size, a color, and the like, with which each object is to be displayed according to a layout of the screen image, by using the user's interaction detected by the detector 190. The rendering unit generates screen images of various layouts including objects, based on the attribute values calculated by the arithmetic unit.

The memory 130 may store a program related to an operation of the electronic device 100 and various pieces of data generated during the operation of the electronic device 100.

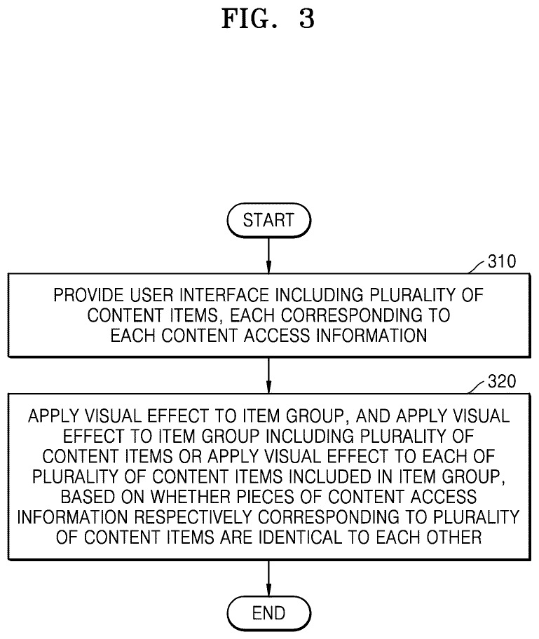

FIG. 3 is a flowchart of an operation method of an electronic device, according to an embodiment.

Referring to FIG. 3, in operation 310, the electronic device 100 may provide a user interface including a plurality of content items, each corresponding to each content access information. According to an embodiment of the disclosure, a user interface that displays an item group including a plurality of content items that enable provision of pieces of content associated with each other may be provided. The plurality of content items may correspond to the same content access information or different content access information used to provide pieces of content associated with each other.

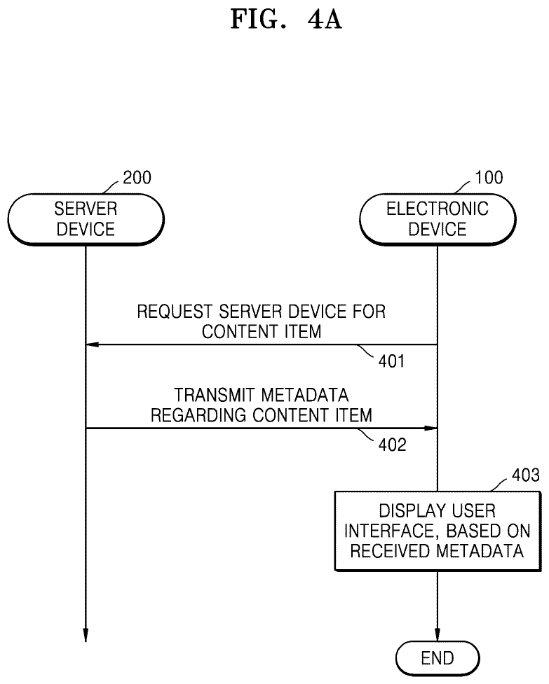

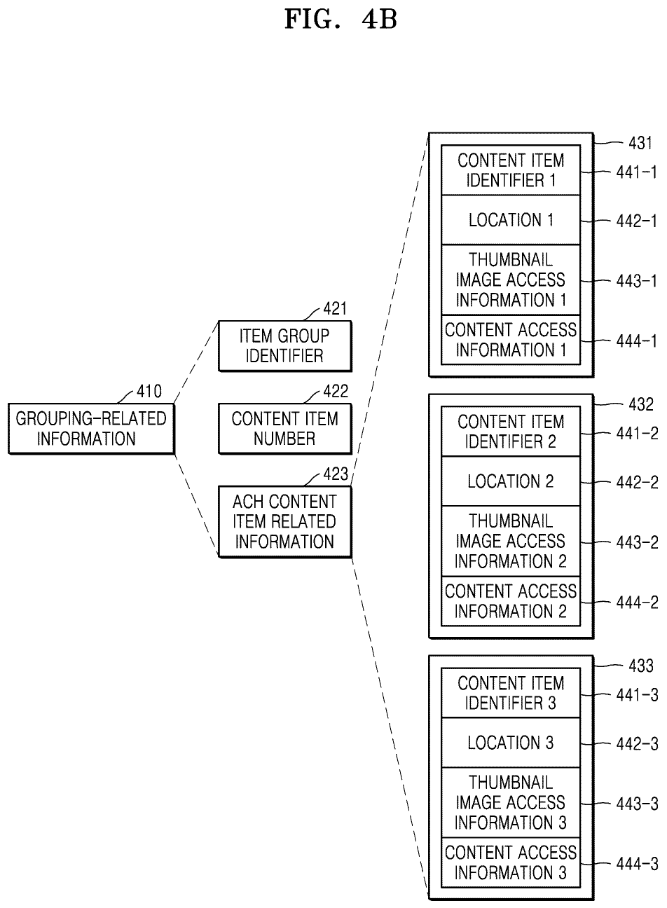

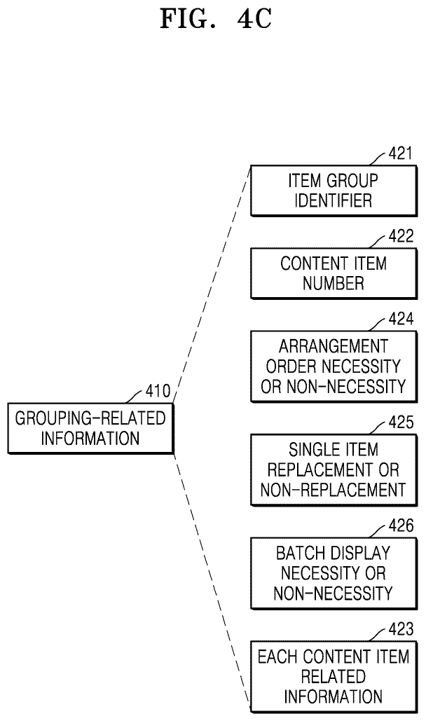

According to an embodiment of the disclosure, the electronic device 100 may provide a user interface that displays the item group, based on metadata regarding one or more content items received from the server device 200. The electronic device 100 may provide a user interface that displays content items, based on the received metadata. For example, the metadata may include an image for displaying content items, and content access information to be linked through the content items. According to an embodiment of the disclosure, the metadata may further include grouping-related information. The grouping-related information may include information for displaying and managing a plurality of content items as a single group. The electronic device 100 may provide a user interface that displays the item group, based on the received grouping-related information. Referring to FIGS. 4A through 4C, an operation, performed by the electronic device 100, of receiving metadata regarding a content item from the server device 200 will now be described.

FIG. 4A is a flowchart of a method, performed by the electronic device 100, of receiving metadata regarding a content item from the server device 200, according to an embodiment.

Referring to FIG. 4A, in operation 401, the electronic device 100 may request the server device 200 for a content item. The electronic device 100 may also request the server device 200 for a format of information about the content item desired to be received. For example, the electronic device 100 may request for information about content desired to be provided through the content item and information about how to display the content item.

In operation 402, the server device 200 may transmit metadata regarding the content item, in response to a content item request from the electronic device 100. The server device 200 may generate and transmit the metadata according to the format requested by the electronic device 100. According to an embodiment of the disclosure, the metadata generated by the server device 200 may include the information about content desired to be provided through each content item and information about how to display the content item. In addition, the metadata generated by server device 200 may include grouping-related information regarding an item group including a plurality of content items. The electronic device 100 may control a communication interface of the electronic device 100 to receive the grouping-related information.

In operation 403, the electronic device 100 may display a user interface, based on the received metadata regarding the content item. For example, the server device 200 may transmit information about an image for displaying content items, and the electronic device 100 may display content items on the user interface according to the received information about the image. According to an embodiment of the disclosure, the electronic device 100 may display, on the user interface, the item group including a plurality of content items capable of providing pieces of content associated with each other.

Referring to FIGS. 4B and 4C, the grouping-related information included in the metadata regarding the content item will now be described. The grouping-related information may include information for displaying or controlling a plurality of content items as a single group. That is, the grouping-related information includes information about a method of setting, as a group, the plurality of content items capable of providing pieces of content associated with each other and displaying or controlling the plurality of content items set as a group. In the disclosure, the ‘pieces of content associated with each other’ may include not only pieces of content with mutually associated contents, such as series content and seasonal content, but also pieces of content with identical contents. For example, the grouping-related information may include information about the content desired to be provided from the item group, information about how to display the item group, information about how to control the display of the item group according to movement of focus or movement of a screen.

FIG. 4B illustrates grouping-related information according to an embodiment.

Referring to FIG. 4B, grouping-related information 410 according to an embodiment of the disclosure may include an item group identifier 421 for identifying an item group, a content item number 422 indicating the number of content items included in the item group, and each content item related information 423 related to each of the content items included in the item group. The each content item related information 423 may include information about each of the content items constituting the item group.

FIG. 4B illustrates that three content items constitute an item group, and the number of content items constituting the item group may be any number greater than or equal to two. Referring to FIG. 4B, the each content item related information 423 may include first content item related information 431, second content item related information 432, and third content item related information 433.

The first content item related information 431 may include, for example, a first content item identifier 441-1 for identifying a first content item, a first location 442-1 including information about a location where the first content item is arranged within the item group, first thumbnail image access information 443-1 including information enabling access to a thumbnail image for displaying the first content item, and first content access information 444-1 including information enabling access to content to be provided via the first content item. For example, the first thumbnail image access information 443-1 may include a link, for example, a Uniform Resource Locator (URL), of a thumbnail image for displaying the first content item. The first content access information 444-1 may include a link, for example, a Uniform Resource Locator (URL), of content to be provided through the first content item.

The second content item related information 432 may include, for example, a second content item identifier 441-2 for identifying a second content item, a second location 442-2 including information about a location where the second content item is arranged within the item group, second thumbnail image access information 443-2 including information enabling access to a thumbnail image for displaying the second content item, and second content access information 444-2 including information enabling access to content to be provided via the second content item. For example, the second thumbnail image access information 443-2 may include a link, for example, a URL, of a thumbnail image for displaying the second content item. The second content access information 444-2 may include a link, for example, a URL, of content to be provided through the second content item.

The third content item related information 433 may include, for example, a third content item identifier 441-3 for identifying a third content item, a third location 442-3 including information about a location where the third content item is arranged within the item group, third thumbnail image access information 443-3 including information enabling access to a thumbnail image for displaying the third content item, and third content access information 444-3 including information enabling access to content to be provided via the third content item. For example, the third thumbnail image access information 443-3 may include a link, for example, a URL, of a thumbnail image for displaying the third content item. The third content access information 444-3 may include a link, for example, a URL, of content to be provided through the third content item.

FIG. 4C illustrates grouping-related information according to an embodiment.

Referring to FIG. 4C, grouping-related information 410 according to an embodiment of the disclosure may include an item group identifier 421, a content item number 422, arrangement order necessity or non-necessity 424, single item replacement or non-replacement 425, batch display necessity or non-necessity 426, and each content item related information 423. The each content item related information 423 may include information about each of the content items constituting the item group. As described above with reference to FIG. 4B, the each content item related information 423 may include, for example, a content item identifier, a location, thumbnail image access information, and content access information.

The arrangement order necessity or non-necessity 424 may include information regarding whether or not the content items need to be arranged within the item group according to a pre-determined arrangement order. For example, when the arrangement order necessity or non-necessity 424 is set as “true”, the content items within the item group need to be arranged according to the pre-determined arrangement order. For example, when the content items are displayed as a single image, arrangement order necessity or non-necessity may be set as “true”. For example, when the arrangement order necessity or non-necessity 424 is set as “false”, even when the arrangement order of the content items is pre-determined, the arrangement order of the content items may be changed to any other arrangement order and the content items may be arranged in the changed arrangement order. For example, when the content items are displayed as independent images, respectively, arrangement order necessity or non-necessity may be set as “false”.

The single item replacement or non-replacement 425 may include information regarding whether or not the content items constituting the item group are replaceable with a single item. For example, when the single item replacement or non-replacement is set to “true”, the plurality of content items constituting the item group may be replaced with a single item as needed during a process of moving a visual effect (e.g., focus or highlight). When the single item replacement or non-replacement is set to “true”, the grouping-related information may further include thumbnail image access information of the single item to be replaced.

The batch display necessity or non-necessity 426 may include information regarding whether or not the content items constituting the item group need to be displayed at one time. For example, when the batch display necessity or non-necessity 426 is set to “true”, the entire item group may be displayed or not displayed as needed during a process of moving a visual effect (e.g., focus or highlight). For example, when the batch display necessity or non-necessity 426 is set to “false”, only some of the content items constituting the item group may be displayed as needed during a process of moving a visual effect (e.g., focus or highlight).

According to an embodiment of the disclosure, the electronic device 100 may control the display of the item group, based on the grouping-related information, while moving a visual effect (e.g., focus or highlight) within the user interface. For example, the electronic device 100 may control the display of the item group and/or the focus displayed on the item group, based on information about the single item replacement or non-replacement 425 and/or information about the batch display necessity or non-necessity 426 while moving a visual effect (e.g., focus or highlight) within the user interface.

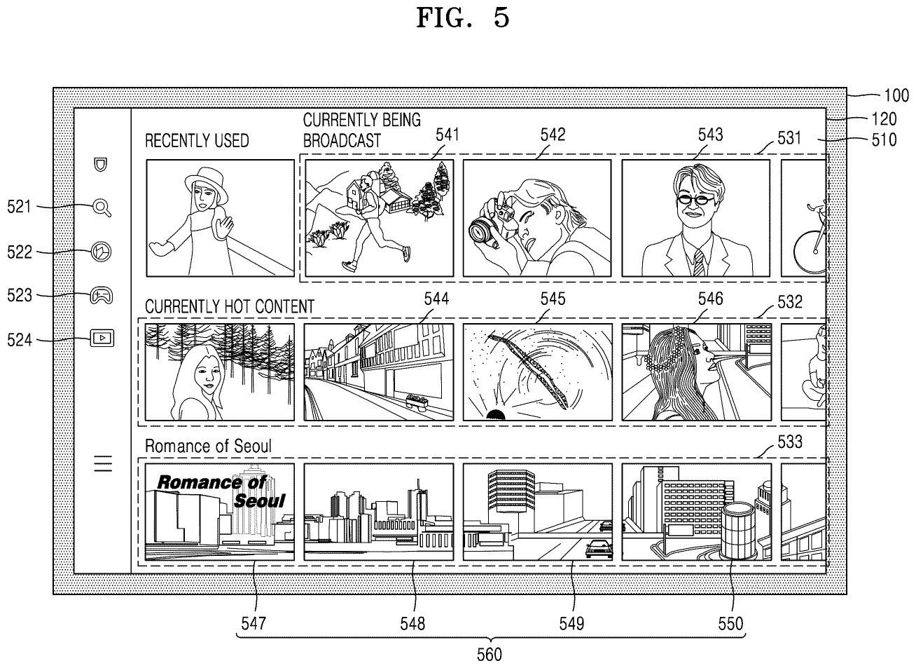

As described above, based on the metadata regarding content items received from the server device 200, the electronic device 100 may output a user interface including content items. An example of the user interface including the content items will now be described with reference to FIG. 5.

FIG. 5 illustrates a user interface screen image 510 of the electronic device 100, according to an embodiment.

Referring to FIG. 5, the electronic device 100 according to an embodiment of the disclosure may provide the user interface screen image 510 through the display 120. The user interface screen image 510 may include a search item 521, a magic screen item 522, a game home item 523, a media home item 524, and content items 541 through 560.

The search item 521 may represent an interface that allows searching for the title of a channel, program, or movie, or an app provided by a server.

The magic screen item 522 may represent an interface that allows output of content harmonized with a surrounding environment or living information, such as weather and time, on a screen, when video content is not viewed through the electronic device 100.

The game home item 523 is a game streaming platform provided by the electronic device 100, and may represent an interface that allows users to select and play games. The game streaming platform may support a user to connect to a cloud, a game console, etc. to immediately play latest/popular games in one gaming hub.

The media home item 524 may represent an interface that allows a user to watch various TV programs and install various apps such as videos, music, sports, and games provided by the server and use them on the electronic device 100. When the media home item 524 is executed, the electronic device 100 may execute the user interface screen image 510 shown in FIG. 5.

The user interface screen image 510 may provide one or more scrolling areas 531, 532, and 533 arranged such that a plurality of content items 541 through 550 are scrollable. FIG. 5 illustrates inclusion of three scrolling areas 531, 532, and 533, and illustrates the plurality of content items 541 through 550 arranged to be scrollable in a horizontal direction in the three scrolling areas 531, 532, and 533.

Scrolling refers to vertically or horizontally sliding of text, image, or video on a monitor or display in a computer display or television product. Scrolling is moving a user's view to show a portion of a larger image that is not be seen in its entirety without changing the layout of text or image.

The scrolling areas 531, 532, and 533 may display a portion of a scrolling list including the content items 541 through 550. Typically, the scrolling list including the content items 541 through 550 may be longer than a scrolling area displayed through the user interface screen image 510, and therefore, only some content items 541 through 550 of the entire scrolling list may be displayed on the scrolling areas 531, 532, and 533.

According to an embodiment of the disclosure, the electronic device 100 may display content items 541, 542, and 543 providing ‘currently-being-broadcast contents’ through the scrolling area 531. The electronic device 100 may display content items 544, 545, and 543 providing ‘recommended contents’ through the scrolling area 532. The electronic device 100 may display content items 547, 548, 549, and 550 providing ‘series content and seasonal content’ through the scrolling area 533. FIG. 5 illustrates an example in which the electronic device 100 provides one ‘recently used content’, but the disclosure is not limited thereto. The electronic device 100 may display content items providing a plurality of pieces of ‘recently used content’ through a scrolling area.

The content items 541 through 550 may be displayed as images. The content items 541 through 550 may be displayed as thumbnail images related to pieces of content desired to be provided. For example, when a content item shows content regarding a movie or a drama, the content item may be displayed using a poster image of the movie or drama or an image showing a certain scene of the movie or drama. For example, when a content item shows a broadcasting channel, the content item may be displayed using a screen image of the broadcasting channel lastly viewed by the user or an image representing a currently-being-broadcast program of the broadcasting channel. For example, when a content item shows history information of content executed by the user, the content item may be displayed using a lastly executed screen image of the content.

According to an embodiment of the disclosure, at least one scrolling list may include one or more item groups 560 including a plurality of content items 547, 548, 549, and 550. The plurality of content items 547, 548, 549, and 550 may be arranged side by side within the item group 560. The content items 547, 548, 549, and 550 constituting the item group 560 may provide pieces of identical content or pieces of mutually related content. For example, the pieces of mutually related content may be pieces of content made up of series, pieces of content made up of seasons, etc. The electronic device 100 may display the plurality of content items 547, 548, 549, and 550 to constitute the one item group 560, by using the number of content items, a location of each content item, and thumbnail image access information in grouping-related information as shown in FIG. 4B.

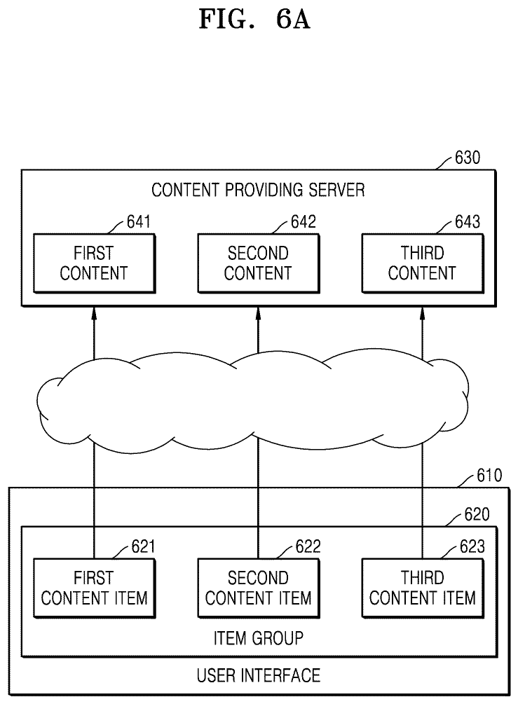

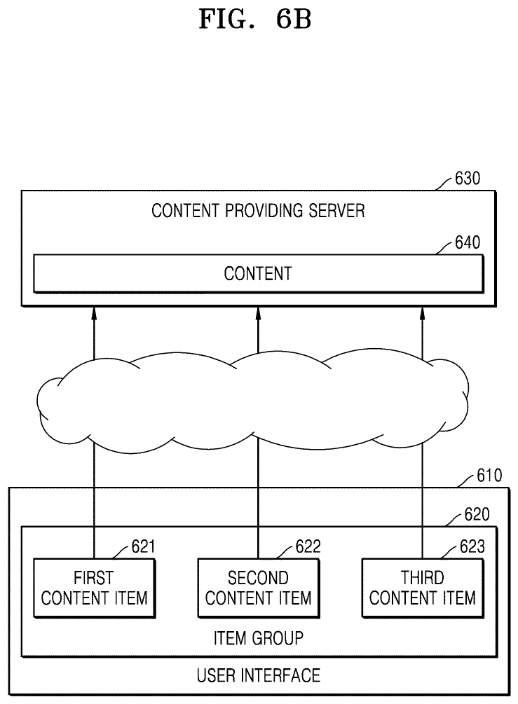

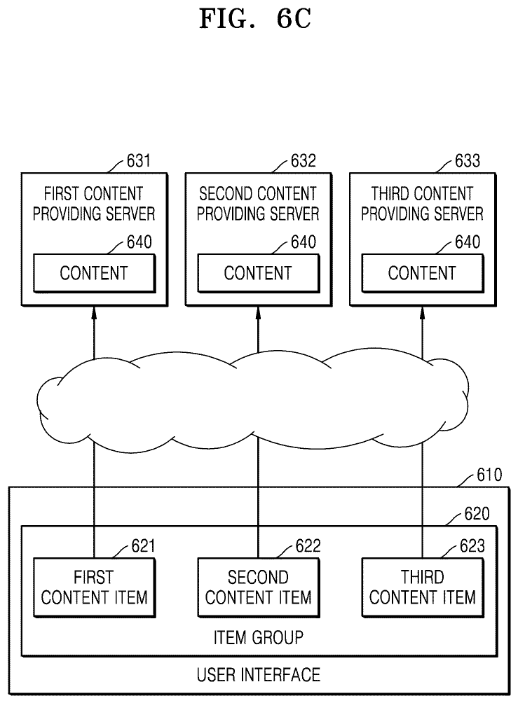

FIGS. 6A through 6C illustrate examples of a user interface according to an embodiment. Referring to FIGS. 6A through 6C, according to an embodiment of the disclosure, a user interface 610 may include content items that enable access to one or more content providing servers. A URL for accessing a content providing server may be connected to each of the content items, and the electronic device 100 may access the content providing server by using the connected URL when the electronic device 100 receives a selection input from a user. In the disclosure, the content providing server may also be referred to as a server.

FIG. 6A illustrates a user interface 610 capable of providing pieces of content with which content items included in an item group are associated, according to an embodiment of the disclosure.

Referring to FIG. 6A, the user interface 610 according to an embodiment of the discosure may include an item group 620 including a first content item 621, a second content item 622, and a third content item 623. In response to a user input of selecting the first content item 621, the electronic device 100 may connect to a content providing server 630 to display first content 641 provided by the content providing server 630. In response to a user input of selecting the second content item 622, the electronic device 100 may connect to the content providing server 630 to display second content 642 provided by the content providing server 630. In response to a user input of selecting the third content item 623, the electronic device 100 may connect to the content providing server 630 to display third content 643 provided by the content providing server 630. That is, the content items constituting the item group 620 may connect to the same content providing server and receive different pieces of content from the same content providing server, and thus the content items constituting the item group 620 may provide different pieces of content.

According to an embodiment of the disclosure, the first, second, and third content 641, 642, and 643 may be pieces of content related to each other. For example, the first, second, and third content 641, 642, and 643 may be related to pieces of content made up of a series, and thus the first, second, and third content 641, 642, and 643 may be pieces of contents providing different series. For example, the first, second, and third content 641, 642, and 643 may be related to pieces of content made up of seasons, and thus the first, second, and third content 641, 642, and 643 may be pieces of contents providing different seasons. As such, by grouping and displaying and managing content items that enable provision of the mutually-related content, a user may be provided with convenience in accessing content desired to be found among the mutually-related content. Moreover, because the item group is displayed over a relatively large area, the item group may be visually emphasized, leading to an enhancement in an advertising effect.

FIG. 6B illustrates a user interface 610 capable of providing pieces of content with which content items included in an item group are associated, according to an embodiment.

Referring to FIG. 6B, the user interface 610 according to an embodiment may include an item group 620 including a first content item 621, a second content item 622, and a third content item 623. In response to a user input of selecting the first content item 621, the electronic device 100 may connect to a content providing server 630 to display content 640 provided by the content providing server 630. In response to a user input of selecting the second content item 622, the electronic device 100 may connect to the content providing server 630 to display the content 640 provided by the content providing server 630. In response to a user input of selecting the third content item 623, the electronic device 100 may connect to the content providing server 630 to display the content 640 provided by the content providing server 630. That is, the content items constituting the item group 620 may connect to the same content providing server, and may provide the same content provided by the same content providing server. As such, by grouping and displaying and managing content items that enable provision of the same pieces of contents, the item group may be visually emphasized by providing an expanded thumbnail image, or an image containing more contents may be provided by providing the expanded thumbnail image. Thus, more pieces of information may be provided regarding content intended to be provided through the item group.

FIG. 6C illustrates a user interface 610 capable of providing pieces of content with which content items included in an item group are associated, according to an embodiment.

Referring to FIG. 6C, the user interface 610 according to an embodiment may include an item group 620 including a first content item 621, a second content item 622, and a third content item 623. In response to a user input of selecting the first content item 621, the electronic device 100 may connect to a first content providing server 631 to display content 640 provided by the first content providing server 631. In response to a user input of selecting the second content item 622, the electronic device 100 may connect to a second content providing server 632 to display second content 640 provided by the second content providing server 632. In response to a user input of selecting the third content item 623, the electronic device 100 may connect to a third content providing server 633 to display content 640 provided by the third content providing server 633. That is, the content items constituting the item group 620 may connect to different content providing servers, and may provide the same content provided by the different content providing servers. By organizing content items that provide the same content from different content providing servers into an item group and exposing them all at once, a user may relatively easily select a content item capable of providing content from a preferred content providing server while determining the content the user wants to view on a home interface screen or searching for specific content. For example, when World Cup broadcast videos for the same match are provided by a plurality of different broadcasters or a plurality of different OTT service providers, the electronic device 100 may group and display content items corresponding to the World Cup broadcast videos provided by the plurality of broadcasters or the plurality of OTT service providers, thereby facilitating the user to check, at a glance, and select a broadcast video from a desired broadcaster or desired OTT service provider. For example, when the same movie or drama content is provided by a plurality of different OTT services, the electronic device 100 may group and display content items corresponding to pieces of movie or drama content provided by the plurality of OTT service providers, thereby facilitating the user to check, at a glance, and select a movie or drama from a desired OTT service provider.

Referring back to FIG. 3, in operation 320, the electronic device 100 may apply a visual effect to the item group, and may apply the visual effect to the item group including the plurality of content items or apply the visual effect to each of the plurality of content items included in the item group, based on whether pieces of content access information respectively corresponding to the plurality of content items are identical to each other.

According to an embodiment of the disclosure, the electronic device 100 may apply a visual effect to the item group including the plurality of content items. The visual effect may include a visual effect displayed on a content item, in order to indicate a selected content item according to a user input received via an input device. The visual effect may be any visual effect for indicating that the content item has been selected. For example, the visual effect may include a focus or highlight, and the focus or highlight may be displayed through a change in the color of a content item, a change in its transparency, a blinking effect, or display of an outline surrounding the content item.

According to an embodiment of the disclosure, the electronic device 100 may determine whether the pieces of content access information respectively corresponding to the plurality of content items included in the item group are identical to each other, based on grouping-related information regarding the content item. For example, the determination may be made using the pieces of content access information regarding the content items included in the grouping-related information illustrated as an example in FIG. 4B.

According to an embodiment of the disclosure, the electronic device 100 may apply the visual effect to the item group including the plurality of content items or apply the visual effect to each of the plurality of content items included in the item group, based on whether the pieces of content access information respectively corresponding to the plurality of content items are identical to each other.

According to an embodiment of the disclosure, when the pieces of content access information respectively corresponding to the plurality of content items are identical to each other, the electronic device 100 may apply the visual effect to the item group including the plurality of content items. Even when the pieces of content access information of the content items included in the item group are the same as each other, when each of these content items is given a visual effect and made selectable, this may enable selection of the content items to be repeatedly attempted for the same content, thereby providing an unnatural experience to the user. Therefore, rather than applying visual effects separately to content items that provide the same content, a visual effect may be applied to the entire item group, and content may be made accessed according to selection of the item group to which the visual effect has been applied.

According to an embodiment of the disclosure, when the pieces of content access information respectively corresponding to the plurality of content items are different from each other, the electronic device 100 may apply the visual effect to each of the plurality of content items included in the item group. When the pieces of content access information respectively corresponding to the plurality of content items are different from each other, each content item needs to be selectable, and thus focus may be displayed on each of the content items.

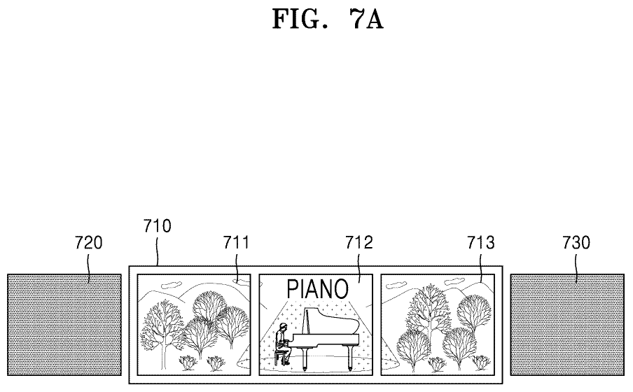

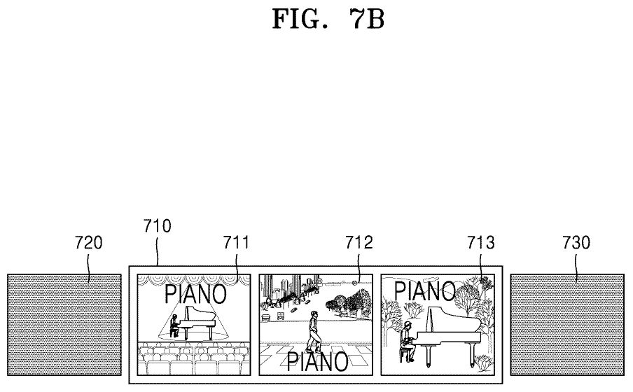

According to an embodiment of the disclosure, the electronic device 100 may display images for the content items constituting then item group as portions of a single thumbnail image, or may display the images as independent thumbnail images. Referring to FIGS. 7A and 7B, an example of displaying images for content items constituting an item group is described.

FIGS. 7A and 7B illustrate examples of an item group displayed within a user interface, according to an embodiment of the disclosure.

FIGS. 7A and 7B illustrate an example in which a user interface displays one item group 710 including three content items and two content items arranged adjacent to each other with the one item group 710 interposed therebetween. For convenience of explanation, the three content items constituting the item group 710 are referred to as a first content item 711, a second content item 712, and a third content item 713, respectively, the content item positioned adjacent to the left side of the item group 710 is referred to as a first adjacent content item 720, and the content item positioned adjacent to the right side of the item group 710 is referred to as a second adjacent content item 730.

Referring to FIG. 7A, according to an embodiment of the disclosure, the first, second, and third content items 711, 712, and 713 constituting the item group 710 may be displayed as a single thumbnail image. The electronic device 100 maycontrol provision of a user interface on which the first, second, and third content items 711, 712, and 713 are displayed as a single thumbnail image. The first, second, and third content items 711, 712, and 713 may be displayed as a plurality of images into which a single thumbnail image is split in accordance with the number of content items of the item group 710 according to a tile size on which the first, second, and third content items 711, 712, and 713 are to be displayed. As the single thumbnail image is displayed through content items arranged side by side, an enlarged thumbnail image may be provided or an expanded thumbnail image may be provided, compared to when the single thumbnail image is displayed through a single content item. Accordingly, the item group may be visually emphasized, an advertising effect of content may be increased, and more pieces of information may be provided regarding content desired to be provided through the item group.

According to an embodiment of the disclosure, the first, second, and third content items 711, 712, and 713 may be connected to the same content providing server as illustrated in FIGS. 6A and 6B. The first, second, and third content items 711, 712, and 713 constituting the item group 710 may be displayed based on grouping-related information received from the same content providing server. For example, the first, second, and third content items 711, 712, and 713 may be displayed as a single thumbnail image received from a content providing server that is accessible to the first, second, and third content items 711, 712, and 713.

According to an embodiment of the disclosure, the first, second, and third content items 711, 712, and 713 may be connected to different content providing servers as illustrated in FIG. 6C. For example, one thumbnail image may be received from one of the different content providing servers that are accessible to the first, second, and third content items 711, 712, and 713, and the first, second, and third content items 711, 712, and 713 may be displayed as one thumbnail image received from one of the different content providing servers.

According to an embodiment of the disclosure, the electronic device 100 may pre-prepare for one thumbnail image for content having high recognition, and may display the first, second, and third content items 711, 712, and 713 as the pre-prepared thumbnail image.

According to an embodiment of the disclosure, the electronic device 100 may obtain thumbnail images related to content through a web search, and may select one thumbnail image from the obtained thumbnail images and display the first, second, and third content items 711, 712, and 713 as the selected one thumbnail image.

According to an embodiment of the disclosure, the electronic device 100 may obtain a thumbnail image automatically generated in relation to content via an artificial intelligence (AI), and the first, second, and third content items 711, 712, and 713 may be displayed as the single thumbnail image automatically generated via the AI. For example, thumbnail images related to content may be obtained through generative AI, and one thumbnail image may be selected from the obtained thumbnail images or a single thumbnail image may be generated based on the obtained thumbnail images. The generative AI is a technology capable of generating new and original content (e.g. text, images, audio, or video), based on the contents learned from existing cases. The electronic device 100 may display the first, second, and third content items 711, 712, and 713 as a single thumbnail image generated via the generative AI. Accordingly, the electronic device 100 may generate a single thumbnail image without having to communicate with an external server.

Referring to FIG. 7B, according to an embodiment of the disclosure, the first, second, and third content items 711, 712, and 713 constituting the item group 710 may be displayed as a plurality of thumbnail images independent from each other.

According to an embodiment of the disclosure, the first, second, and third content items 711, 712, and 713 may be connected to the same content providing server as illustrated in FIGS. 6A and 6B. The first, second, and third content items 711, 712, and 713 constituting the item group 710 may be displayed based on grouping-related information received from the same content providing server. For example, the first, second, and third content items 711, 712, and 713 may be displayed as three independent thumbnail images received from a content providing server that is accessible to the first, second, and third content items 711, 712, and 713.

For example, when the first, second, and third content items 711, 712, and 713 provide identical pieces of content, the three independent thumbnail images may be displayed as different poster images, images featuring different characters, or images featuring different main scenes.

For example, when the first, second, and third content items 711, 712, and 713 provide related but not identical pieces of content, each of the three independent thumbnail images may be displayed as a thumbnail image for a corresponding series or corresponding season.

According to an embodiment of the disclosure, the first, second, and third content items 711, 712, and 713 may be connected to different content providing servers as illustrated in FIG. 6C. The first, second, and third content items 711, 712, and 713 may be displayed independently as thumbnail images respectively received from different content providing servers.

According to an embodiment of the disclosure, the electronic device 100 may determine an arrangement order of the first, second, and third content items 711, 712, and 713 within the item group 710, based on accessibility information for the different content providing servers. The electronic device 100 may control provision of a user interface in which the plurality of content items 711, 712, and 713 are arranged in the arrangement order determined based on the accessibility information for the different content providing servers. For example, the accessibility information for the different content providing servers may include at least one of whether the content providing servers are logged in, whether the content providing servers are subscribed, or the frequency of use of the content providing servers.

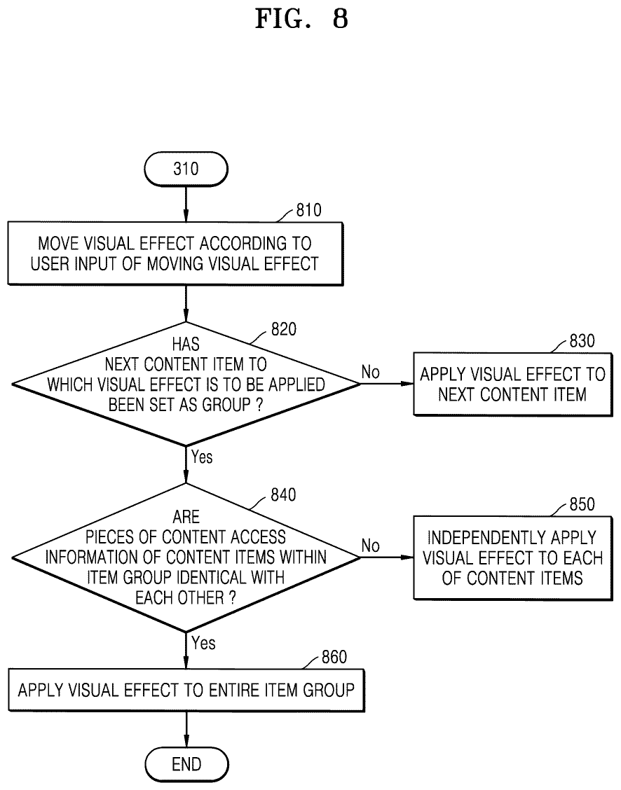

A method of applying a visual effect to an item group displayed as such examples will be described with reference to FIG. 8.

FIG. 8 is a flowchart of a method, performed by an electronic device, of displaying a focus, according to an embodiment. FIG. 8 may correspond to a detailed flowchart of embodiments of a method of applying a visual effect to an item group in operation 320 of FIG. 3.

Referring to FIG. 8, in operation 810, the electronic device 100 may move a visual effect of guiding that a content item is selectable, according to a user input corresponding to movement of the visual effect. For example, the electronic device 100 may display the visual effect on a content item disposed at a predetermined location when first executing a home user interface. A location where the visual effect is to be initially displayed when the home user interface is executed may be previously set. Thereafter, the electronic device 100 may receive an input of moving the visual effect from, for example, the control device 300, and may move the visual effect according to this input.

In operation 820, the electronic device 100 may determine (or identify) whether a next content item to which a visual effect is to be applied has been set as a group. For example, according to a direction in which a visual effect is to move, the next content item to which the visual effect is to be applied may be determined. The determination as to whether the next content item to which the visual effect is to be applied has been set as a group may be made based on whether the next content item to which the visual effect is to be applied is included in an item group. For example, the electronic device 100 may perform the determination, based on grouping-related information included in metadata regarding the content item. For example, the electronic device 100 may determine that the content item is included in the item group when the grouping-related information exists, in correspondence to the next content item to which the visual effect is to be applied.

In operation 820, when it is determined that the next content item to which the visual effect is to be applied is not set as a group, the electronic device 100 may proceed to operation 830 to display focus on the next content item. For example, in operation 830, a method of applying a visual effect to the next content item not set as a group may be the same as a method of applying a visual effect to other content items not included in the item group.

In operation 830, the electronic device 100 may apply a visual effect to the next content item not set as a group, according to a typical method of applying a visual effect to a single content item. For example, in operation 830, a shape of, a color of, and a thickness of focus (or highlight) displayed on the next content item not set as a group may be the same as those of focus (or highlight) displayed on the other content items not included in the item group.

In operation 820, when it is determined that the next content item to which the visual effect is to be applied is set as a group, the electronic device 100 may proceed to operation 840.

In operation 840, the electronic device 100 may determine (or identify) whether pieces of content access information of the content items within the item group are the same as each other. For example, when content items constituting the item group connect to the same single content providing server and provide the same content provided by the same content providing server, the electronic device 100 may determine that the pieces of content access information of the content items within the item group are the same as each other. For example, when the content items constituting the item group connect to the same single content providing server but provide different pieces of contents, or when the content items constituting the item group connect to different content providing servers, the electronic device 100 may determine that the pieces of content access information of the content items within the item group are different from each other. For example, the electronic device 100 may perform the determination, based on grouping-related information included in metadata regarding the content item. For example, as illustrated in FIG. 4B, the grouping-related information included in the metadata may include content access information for each content item, and the electronic device 100 may compare the pieces of content access information of the content items with each other to determine whether the pieces of content access information of the content items are the same as each other.

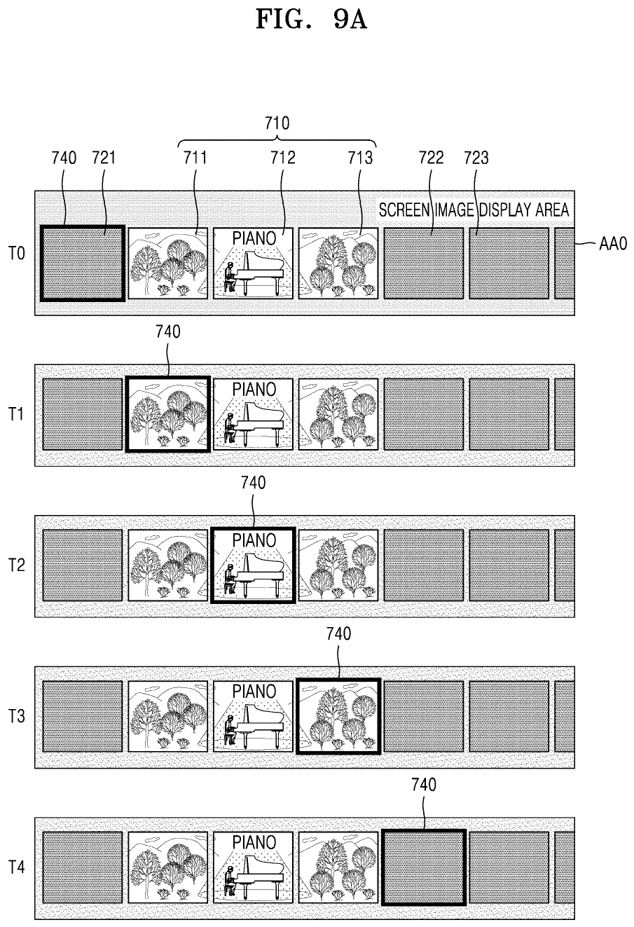

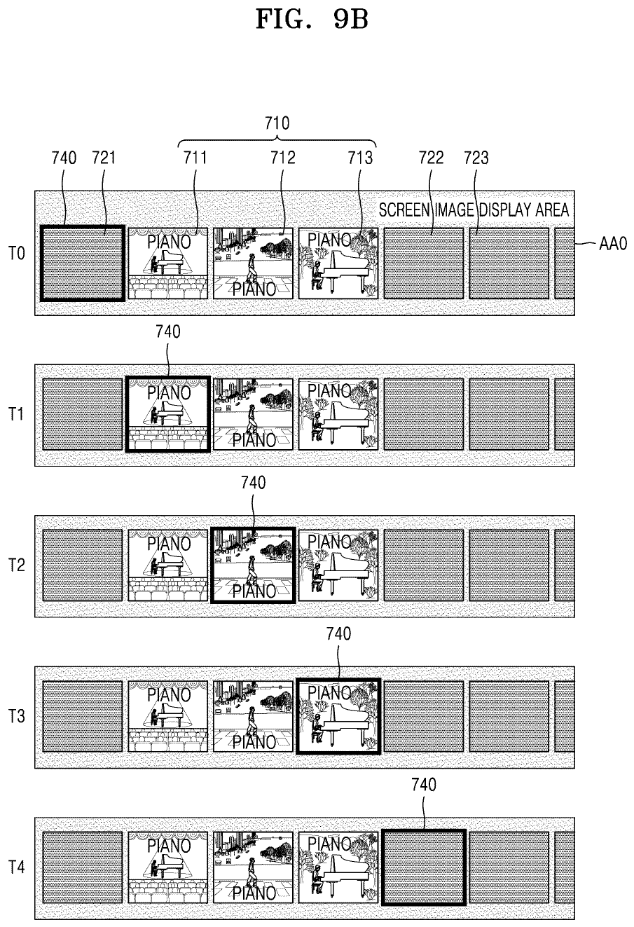

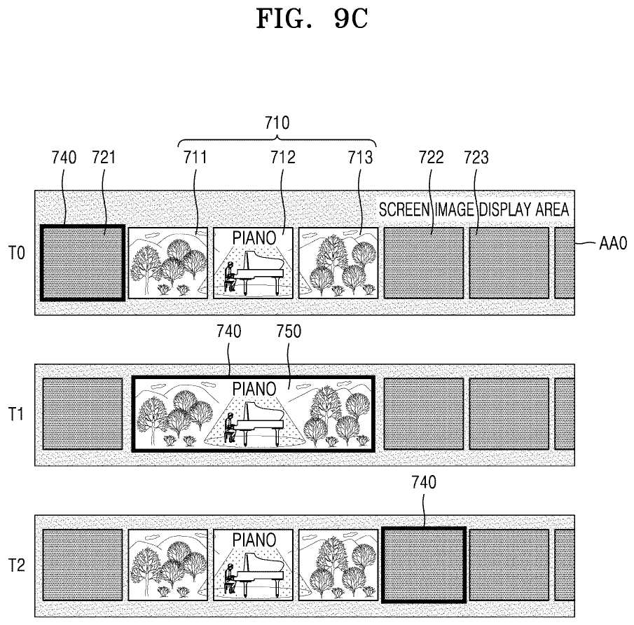

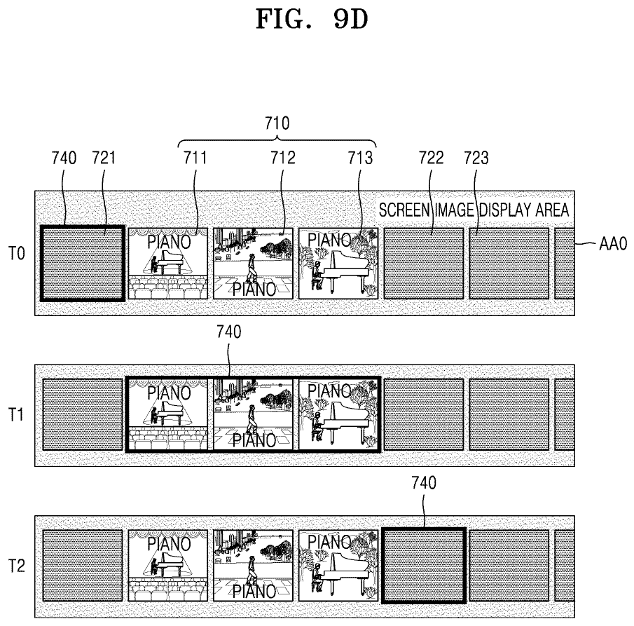

In operation 840, when it is determined that the pieces of content access information of the content items within the item group are not identical to each other, the electronic device 100 may proceed to operation 850, and thus may independently apply a visual effect to each of the content items constituting the item group. Referring to FIGS. 9A and 9B, an example of independently displaying a visual effect to each of the content items constituting the item group is described. FIGS. 9A and 9B illustrate an example of applying a visual effect by displaying focus on a content item.

FIGS. 9A and 9B are reference diagrams for explaining a method of displaying a focus on an item group, according to an embodiment of the disclosure.

Referring to FIGS. 9A and 9B, according to an embodiment of the disclosure, a user interface screen AA0 may display a portion of a scrolling list, wherein the scrolling list may include an item group 710 including at least a plurality of content items. FIGS. 9A and 9B illustrate an example in which the user interface screen AA0 displays one item group 710 including three content items and three content items arranged adjacent to each other with the one item group 710 interposed therebetween. For convenience of explanation, the three content items constituting the item group 710 are referred to as the first content item 711, the second content item 712, and the third content item 713, respectively, the content item positioned adjacent to the left side of the item group 710 is referred to as a first adjacent content item 721, and the two content items positioned adjacent to the right side of the item group 710 are referred to as a second adjacent content item 722 and a third adjacent content item 723.

For example, as illustrated in FIGS. 9A and 9B, the electronic device 100 may display a focus 740 on the first adjacent content item 721 at a time point TO (or an immediately preceding time point, an initial time point, or a previous time point), and then, at a time point T1, display a focus 740 on a next content item according to an input of moving the focus 740. Thereafter, at each of time points T2, T3, and T4, similar to the time point T1, the electronic device 100 may display the focus 740 on the next content item according to the input of moving the focus 740. FIG. 9A and FIG. 9B illustrate an example in which an input of moving the focus 740 to the right is received at all of the time points T1 through T4.

Referring to FIG. 9A, according to an embodiment of the disclosure, the first, second, and third content items 711, 712, and 713 may be displayed as three images into which one thumbnail image is split, respectively. When it is determined that the pieces of content access information of the first, second, and third content items 711, 712, and 713 are not identical with each other, the electronic device 100 may independently display the focus 740 on each of the first, second, and third content items 711, 712, and 713. Accordingly, at the time points T2, T3, and T4, the focus 740 may be displayed sequentially on the first content item 711, the second content item 712, and the third content item 713, respectively. That is, according to an input of moving the focus 740 to the right after the time point TO, the focus 740 may be displayed on the first content item 711 at the time point T1. According to an input of moving the focus 740 to the right after the time point T1, the focus 740 may be displayed on the second content item 712 at the time point T2. According to an input of moving the focus 740 to the right after the time point T2, the focus 740 may be displayed on the third content item 713 at the time point T3.

Referring to FIG. 9B, according to an embodiment of the disclosure, the first, second, and third content items 711, 712, and 713 may be displayed as a plurality of thumbnail images independent from each other. When it is determined that the pieces of content access information of the first, second, and third content items 711, 712, and 713 are not identical with each other, the electronic device 100 may independently display the focus 740 on each of the first, second, and third content items 711, 712, and 713. Accordingly, at the time points T1, T2, and T3, the focus 740 may be displayed sequentially on the first content item 711, the second content item 712, and the third content item 713, respectively.

Referring back to FIG. 8, in operation 840, when it is determined that the pieces of content access information of the content items within the item group are the same as each other, the electronic device 100 may proceed to operation 860 to apply a visual effect to the entire item group. Referring to FIGS. 9C and 9D, an example of applying a visual effect to the entire content group will now be described. FIGS. 9C and 9D illustrate an example of applying a visual effect by displaying focus on a content item.

FIGS. 9C and 9D are reference diagrams for explaining a method of displaying a focus on an item group, according to an embodiment.

Referring to FIGS. 9C and 9D, according to an embodiment of the disclosure, a user interface screen AA0 may display a portion of a scrolling list, wherein the scrolling list may include an item group 710 including at least a plurality of content items. FIGS. 9C and 9D illustrate an example in which an item group 710 including first, second, and third content items 711, 712, and 713, a first adjacent content item 721 positioned adjacent to the left side of the item group 710, and second and third adjacent content items 722 and 723 positioned adjacent to the right side of the item group 710 are displayed on the user interface screen AA0.

For example, as illustrated in FIGS. 9C and 9D, the electronic device 100 may display a focus 740 on the first adjacent content item 721 at a time point TO (or an immediately preceding time point, an initial time point, or a previous time point), and, at a time point T1, display a focus 740 on a next content item according to an input of moving the focus 740. Also at the time point T2, similar to the time point T1, the electronic device 100 may display the focus 740 on the next content item according to the input of moving the focus 740. FIG. 9C and FIG. 9D illustrate an example in which an input of moving the focus 740 to the right is received at all of the time points T1 and T2.

Referring to FIG. 9C, according to an embodiment of the disclosure, the first, second, and third content items 711, 712, and 713 may be displayed as three images into which one thumbnail image is split, respectively. When it is determined that the pieces of content access information of the first, second, and third content items 711, 712, and 713 are identical with each other, the electronic device 100 may display the focus 740 on the entire item group 710.

According to an embodiment of the disclosure, when the electronic device 100 displays the focus 740 on the entire item group 710, the electronic device 100 may display the item group 710 as an unsplit single thumbnail image 750. The focus 740 may be displayed as an outline surrounding the entire unsplit single thumbnail image 750. For example, the electronic device 100 may remove two content items from the first, second, and third content items 711, 712, and 713, and change a size of the remaining one content item, to thereby display the item group 710 as one content item represented by the unsplit single thumbnail image 750. For example, the electronic device 100 may generate arbitrary items in a space between the first and second content items 711 and 712 and a space between the second and third content items 712 and 713, and may fill a space between content items with an image via the arbitrary items. Accordingly, the electronic device 100 may display the item group 710 as an unsplit single thumbnail image 750. For example, the electronic device 100 may maintain the first, second, and third content items 711, 712, and 713 without changes, and generate a new single content item that is arranged to overlap the first, second, and third content items 711, 712, and 713, so as to display the item group 710 as the single unsplit thumbnail image 750 through the newly generated single content item.

However, embodiments are not limited thereto, and, even when the focus 740 is displayed on the entire item group 710, images of the first, second, and third content items 711, 712, and 713 may not be changed and may remain the same as when the focus 740 is not displayed on the item group 710. That is, the content items included in the item group 710 may remain displayed in the form of separate tiles, and the focus 740 may be displayed as an outline surrounding all of the first, second, and third content items 711, 712, and 713 displayed in the form of separate tiles.

Referring to FIG. 9D, according to an embodiment of the disclosure, the first, second, and third content items 711, 712, and 713 may be displayed as a plurality of thumbnail images independent from each other. When it is determined that the pieces of content access information of the first, second, and third content items 711, 712, and 713 are identical with each other, the electronic device 100 may display the focus 740 on the entire item group 710. At the time point T1, the focus 740 may be displayed to surround all of the first, second, and third content items 711, 712, and 713 constituting the item group 710.

According to an embodiment of the disclosure, based on grouping-related information received from a content providing server, the first, second, and third content items 711, 712, and 713 may be displayed as a plurality of thumbnail images independent from each other. In this case, a user may recognize the first, second, and third content items 711, 712, and 713 as items that provide separate pieces of content. Accordingly, when the focus 740 is displayed on each of the first, second, and third content items 711, 712, and 713 that provide the same content, the user may feel confused when using a service, because results of inputs of selecting content items, respectively, are identical with each other. That is, by repeatedly attempting to select content items for the same content, an unnatural experience may be provided to the user. However, by determining a focus display method of a plurality of content items constituting the item group 710, based on whether the pieces of content access information of the content items are the same as each other, rather than whether the content items have been expressed independently, a user may be prevented from feeling confused when using a service. That is, by displaying, at once, a focus on the content items that provide the same content, the user may easily recognize that the content items provide the same content. According to an embodiment of the disclosure, even when a focus is set to be independently displayed on each of the first, second, and third content items 711, 712, and 713 capable of providing the same content, in the grouping-related information received from the content providing server, the electronic device 100 may display the focus 740 on all of the first, second, and third content items 711, 712, and 713 in order to achieve use convenience of a user.

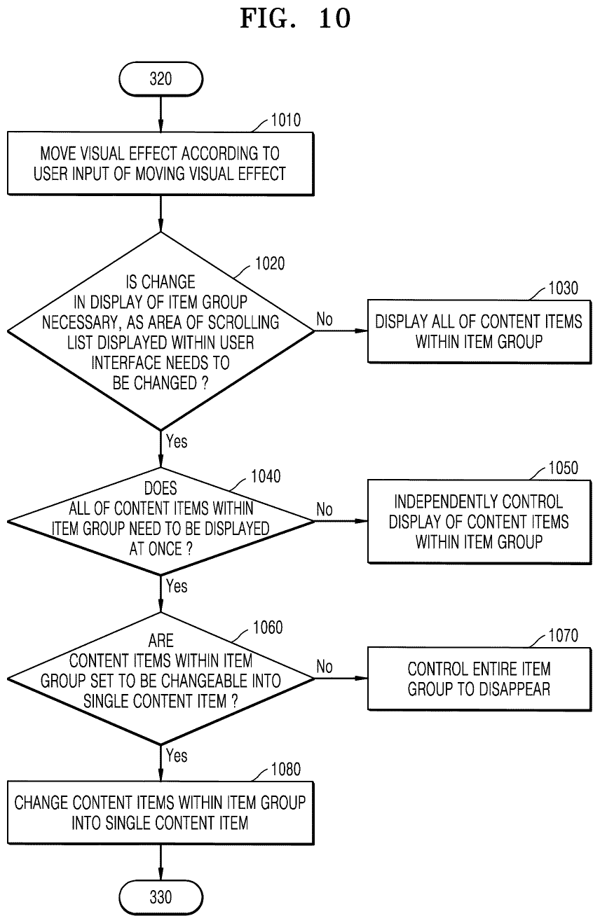

As such, according to an input of moving a visual effect within a user interface, the visual effect may be applied independently to each of the plurality of content items within the item group or may be applied to the entire item group. In a process of moving a focus, a case where display of an item group needs to be changed may occur, and an example of a method of controlling the display of the item group when the display of the item group needs to be changed will now be described with reference to FIG. 10.

FIG. 10 is a flowchart of a method, performed by an electronic device, of controlling display of an item group when moving a visual effect, according to an embodiment.

Referring to FIG. 10, in operation 1010, the electronic device 100 may move a visual effect of guiding that a content item is selectable, according to a user input corresponding to movement of the visual effect. When receiving a user input of moving a visual effect, the electronic device 100 may control the visual effect to move in response to the user input so that a content item to which the visual effect is applied changes. Simultaneously, when receiving a user input of moving the visual effect, the electronic device 100 may control display of the item group, based on at least one of whether the plurality of content items constituting the item group are independently displayable or whether the plurality of content items are changeable into a single content item. An operation of control display of an item group will be described in detail through operations 1020 through 1080.

In operation 1020, the electronic device 100 may determine (or identify) whether a change in the display of the item group is necessary, as an area of the scrolling list displayed within the user interface needs to be changed. For example, when a visual effect is applied to a content item positioned on an edge of a user interface screen and, according to an input of moving the visual effect, the visual effect needs to move to a next content item not displayed on the user interface screen, the area of the scrolling list displayed within the user interface needs to be changed. When the area of the scrolling list displayed within the user interface is changed and at least portion of the item group deviates from the user interface, it may be determined that the display of the item group needs to be changed.

When it is determined in operation 1020 that the display of the item group does not need to be changed even when the area of the scrolling list displayed within the user interface needs to be changed, the electronic device 100 may proceed to operation 1030 to display all of the content items within the item group. Only locations of the content items within the item group may be changed within the user interface.

When it is determined in operation 1020 that the display of the item group needs to be changed because the area of the scrolling list displayed within the user interface needs to be changed, the electronic device 100 may proceed to operation 1040. In operation 1040, the electronic device 100 may determine (or identify) whether batch display of the content items within the item group is necessary. That is, the electronic device 100 may determine whether all of the content items within the item group need to be displayed at once. For example, when the content items within the item group are displayed as a single thumbnail image, and a portion of the single thumbnail image is cropped, making it difficult to identify the content intended to be provided as a cropped image, it may be determined that all of the content items within the item group need to be displayed at once. For example, the electronic device 100 may determine whether all of the content items within the item group need to be displayed at once, based on grouping-related information included in metadata regarding the content item. For example, when the batch display necessity or non-necessity 426 is set as “true” in the grouping-related information 410 received from the content providing server, the electronic device 100 may determine whether all of the content items within the item group need to be displayed at once.

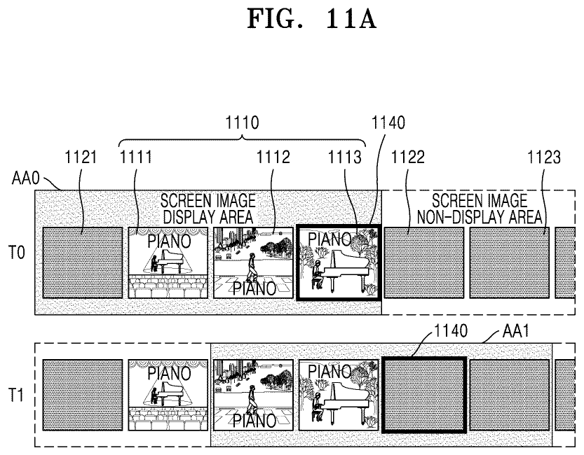

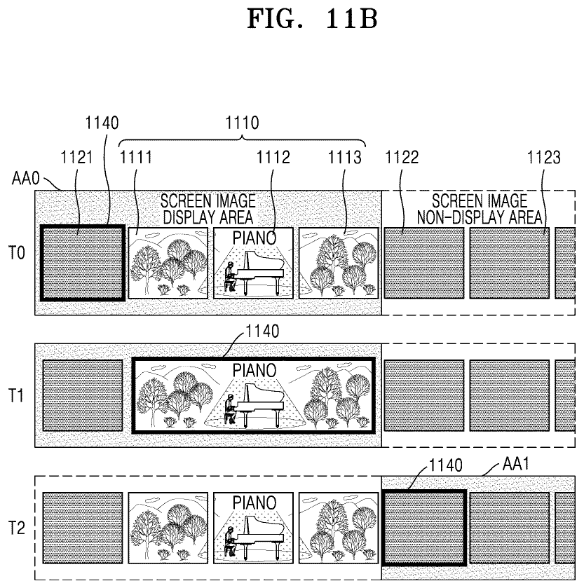

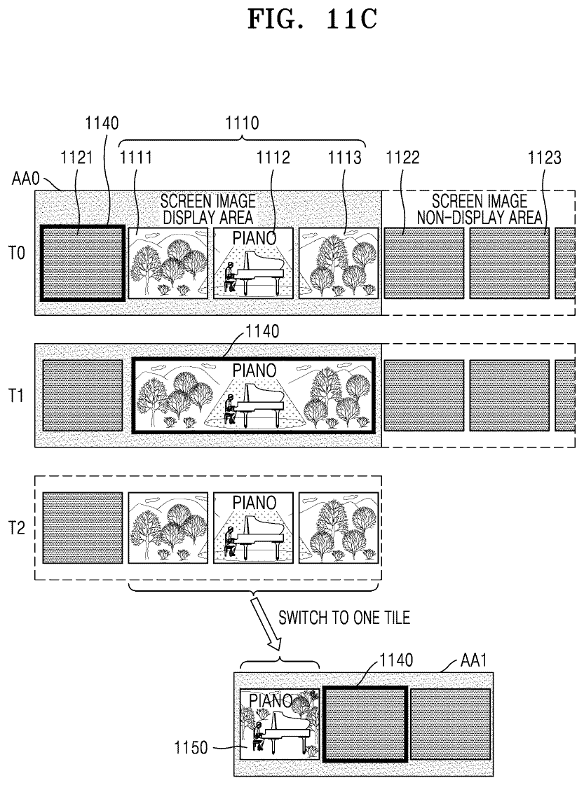

In operation 1040, when it is determined that all of the content items within the item group does not need to be displayed at once, the electronic device 100 may proceed to operation 1050, and thus may independently control the display of the content items within the item group. Referring to FIG. 11A, an example of independently controlling the display of the content items within the item group when it is determined that the display of the item group needs to be changed because the area of the scrolling list displayed within the user interface needs to be changed is described. FIG. 11A illustrates an example of applying a visual effect by displaying focus on a content item.

FIG. 11A is a reference diagram for explaining a method of displaying an item group when a focus moves from the item group to an adjacent next content item, according to an embodiment.

Referring to FIG. 11A, according to an embodiment of the disclosure, user interface screens AA0 and AA1 may display a portion of a scrolling list, wherein the scrolling list may include an item group 1110 including at least a plurality of content items.

At a time point TO (or an immediately preceding time point, an initial time point, or a previous time point), a first adjacent content item 1121 and first, second, and third content items 1111, 1112, and 1113 constituting the item group 1110 among the scrolling list may be displayed within the user interface screen AA0. At the time point TO, a focus 1140 may be displayed on the third content item 1113 within the item group 1110. Then, at a time point T1, the focus 1140 may be displayed on a next content item according to an input of moving the focus 1140 to the right.

According to an embodiment of the disclosure, the focus 1140 is displayed on the third content item 1113 positioned at the edge of the user interface screen AA0 at the time point TO, and thus the focus 1140 needs to move to a next content item not displayed on the user interface screen AA0, so that an area of the scrolling list displayed within the user interface screen AA0 needs to be changed. For example, when the area of the scrolling list displayed within the user interface screen AA0 is changed, the area of the scrolling list may be set to move by an area in which two content items are placed. As the area of the scrolling list displayed within the user interface screen AA0 moves by the area in which two content items are placed, it may be determined that at least a portion of the item group 1110 needs to deviate from the user interface screen AA0. When it is determined that the first, second, and third content items 1111, 1112, and 1113 within the item group 1110 do not need to be displayed all at once, the electronic device 100 may independently control display of the first, second, and third content items 1111, 1112, and 1113 within the item group 1110. For example, at the time point T1, the electronic device 100 may allow the first content item 1111, which is to deviate from the screen among the item group 1110, to disappear from the user interface screen AA1, and may display only the remaining second and third content items 1112 and 1113.

Referring back to FIG. 10, in operation 1040, when it is determined that all of the content items within the item group meed to be displayed at once, the electronic device 100 may proceed to operation 1060. In other words, when independent display of the content items within the item group is not possible, the electronic device 100 may proceed to operation 1060. In operation 1060, the electronic device 100 may determine whether the content items within the item group are set to be changeable into a single content item. According to an embodiment of the disclosure, the electronic device 100 may determine whether the content items within the item group are changeable into a single content item, based on the grouping-related information included in the metadata regarding the content item. For example, when the single item replacement or non-replacement 425 is set as “true” in the grouping-related information 410 received from the content providing server, the electronic device 100 may determine that the content items within the item group are changeable into a single content item.

In operation 1060, when the content items within the item group are not set to be changeable into the single content item, the electronic device 100 may proceed to operation 1070 to allow the entire item group to disappear. In other words, when change of the content items within the item group into the single content item is not possible, the electronic device 100 may control the entire item group to disappear. Referring to FIG. 11B, an example of allowing the entire item group to disappear, when the display of the item group needs to be changed because the area of the scrolling list displayed within the user interface needs to be changed will now described.

In operation 1060, when the content items within the item group are set to be changeable into the single content item, the electronic device 100 may proceed to operation 1080 to change the content items within the item group into the single content item. In other words, when change of the content items within the item group into the single content item is possible, the electronic device 100 may control the content items within the item group to be changed into the single content item. Referring to FIGS. 11B and 11C, an example of changing the content items within the item group into the single content item, when the display of the item group needs to be changed because the area of the scrolling list displayed within the user interface needs to be changed will now described. FIGS. 11B and 11C illustrate an example of applying a visual effect by displaying a focus on a content item.

FIGS. 11B and 11C are reference diagrams for explaining a method of displaying an item group when a focus moves from the item group to an adjacent next content item, according to an embodiment.

Referring to FIGS. 11B and 11C, according to an embodiment of the disclosure, user interface screens AA0 and AA1 may display a portion of a scrolling list, wherein the scrolling list may include an item group 1110 including at least a plurality of content items.

At a time point TO (or an immediately preceding time point, an initial time point, or a previous time point), a first adjacent content item 1121 and first, second, and third content items 1111, 1112, and 1113 constituting the item group 1110 among the scrolling list may be displayed within the user interface screen AA0. At the time point TO, a focus 1140 may be displayed on the first adjacent content item 1121. Then, at a time point T1, the focus 1140 may be displayed on the item group 1110, which is a next content item, according to an input of moving the focus 1140 to the right. FIG. 11B and FIG. 11C illustrate an example in which the focus 1140 is displayed on the entire item group 1110.

Then, at a time point T2, the focus 1140 may be displayed on the next content item according to the input of moving the focus 1140 to the right. The focus 1140 is displayed on the item group 1110 positioned at the edge of the user interface screen AA0 at the time point T1, which is an immediately preceding time point with respect to the time point T2, and thus the focus 1140 needs to move to a next content item not displayed on the user interface screen AA0, so that an area of the scrolling list displayed within the user interface screen AA0 needs to be changed. For example, when the area of the scrolling list displayed within the user interface screen AA0 is changed, the area of the scrolling list may be set to move by an area in which two content items are placed. As the area of the scrolling list displayed within the user interface screen AA0 moves by the area in which two content items are placed, it may be determined that at least a portion of the item group 1110 needs to deviate from the user interface screen AA0.

Referring to FIG. 11B, when all of the first, second, and third content items 1111, 1112, and 1113 in the item group 1110 need to be displayed at once, and the first, second, and third content items 1111, 1112, and 1113 in the item group 1110 may be not-set to be changeable into a single content item, the electronic device 100 may allow the entire item group 1110 to disappear from the user interface screen AA1, and may display the second adjacent content item 1122, which is a next content item to be focused, on the edge of the user interface screen AA1.

Referring to FIG. 11C, when all of the first, second, and third content items 1111, 1112, and 1113 in the item group 1110 need to be displayed at once, and the first, second, and third content items 1111, 1112, and 1113 in the item group 1110 are set to be changeable into a single content item 1150, the electronic device 100 may change the first, second, and third content items 1111, 1112, and 1113 in the item group 1110 into the single content item 1150.

According to an embodiment of the disclosure, information regarding a thumbnail image for displaying the single content item 1150 may be included in the metadata (e.g., grouping-related information) received from the content providing server.

According to an embodiment of the disclosure, the first, second, and third content items 1111, 1112, and 1113 within the item group 1110 are pre-set to be changeable into the single content item 1150, but information regarding a thumbnail image for displaying the single content item 1150 may be omitted. For example, according to the metadata received from the content providing server, information regarding the single item replacement or non-replacement 425 within the grouping-related information 410 may be set as “true”, but the metadata (e.g., grouping-related information) may not include the information regarding the thumbnail image for displaying the single content item 1150. In this case, the electronic device 100 may obtain or determine one thumbnail image related to the item group 1110 according to various methods, and display the single content item 1150 as the obtained or determined one thumbnail image.

For example, when the first, second, and third content items 1111, 1112, and 1113 are displayed as a plurality of independent thumbnail images, the electronic device 100 may select one thumbnail image from the independent thumbnail images, based on image analysis, title analysis, or main character information analysis, and display the single content item 1150 as the selected thumbnail image.

For example, the electronic device 100 may obtain thumbnail images related to content through a web search, and may select one thumbnail image from the obtained thumbnail images and display the single content item 1150 as the selected thumbnail image.

For example, the electronic device 100 may obtain a thumbnail image automatically generated in relation to content via AI, and may display the single content item 1150 as the thumbnail image automatically generated via AI.

For example, the electronic device 100 may obtain a poster image related to content through a server (or an external server) that stores poster images of pieces of content, and may display the single content item 1150 as the obtained poster image.

Although not illustrated, according to an embodiment of the disclosure, when an input of selecting the single content item 1150 is received by moving the focus 1140 back to the single content item 1150 after the time point T2, the electronic device 100 may control display of the item group 1110, based on whether the pieces of content access information of the first, second, and third content items 1111, 1112, and 1113 constituting the item group 1110 are identical to each other. For example, when the pieces of content access information of the first, second, and third content items 1111, 1112, and 1113 constituting the item group 1110 are identical to each other, the electronic device 100 may immediately provide content provided through the identical pieces of content access information according to the input of selecting the single content item 1150. For example, when the pieces of content access information of the first, second, and third content items 1111, 1112, and 1113 constituting the item group 1110 are different from each other, in response to the input of selecting the single content item 1150, the electronic device 100 may change the single content item 1150 to the first, second, and third content items 1111, 1112, and 1113 so that one of the first, second, and third content items 1111, 1112, and 1113 may be selected as originally constituted.

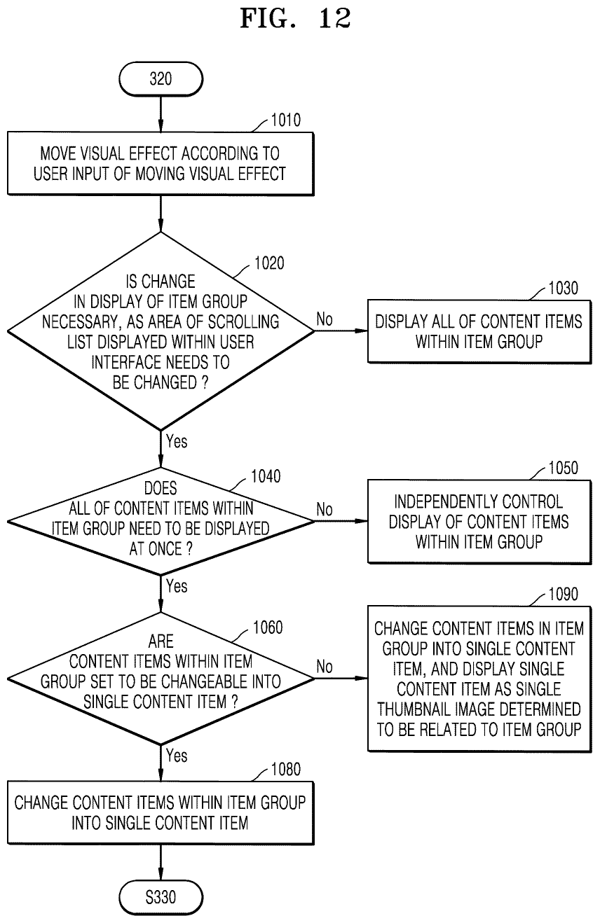

FIG. 12 is a flowchart of a method, performed by an electronic device, of controlling display of an item group when moving a focus, according to an embodiment. Because the detailed explanation given above with reference to FIG. 10 may be equally applied to operations 1010 through 1080 in FIG. 12, a detailed description of the operations 1010 through 1080 in FIG. 12 will be omitted below.

Referring to FIG. 12, in operation 1020, it is determined that the display of the item group needs to be changed, because the area of the scrolling list displayed in the user interface needs to be changed. In operation 1040, it is determined that all of the content items in the item group needs to be displayed at once. In operation 1060, when the content items in the item group are not set to be changeable into a single content item, the electronic device 100 may proceed to operation 1090 to change the content items in the item group into the single content item, and display the single content item as a single thumbnail image determined to be related to the item group. When independent display of the content items within the item group is not possible and a change of the content items within the item group into the single content item is not possible, the electronic device 100 may proceed to operation 1090 to change the content items within the item group into the single content item displayed as a thumbnail image related to the item group. For example, according to the metadata received from the content providing server, when information regarding the single item replacement or non-replacement 425 is not included in the grouping-related information 410, the electronic device 100 may obtain or determine a single thumbnail image determined to be related to the item group, and may change the content items in the item group into the single content item displayed as the thumbnail image.

For example, when the content items constituting the item group are displayed as independent thumbnail images, the electronic device 100 may select one thumbnail image from the independent thumbnail images, based on image analysis, title analysis, or main character information analysis, and display the single content item as the selected thumbnail image.

For example, the electronic device 100 may obtain thumbnail images related to content through a web search, and may select one thumbnail image from the obtained thumbnail images and display the single content item as the selected thumbnail image.

For example, the electronic device 100 may obtain a thumbnail image automatically generated in relation to content via AI, and may display the single content item as the thumbnail image automatically generated via AI.

For example, the electronic device 100 may obtain a poster image related to content through a server (or an external server) that stores poster images of pieces of content, and may display the single content item as the obtained poster image.

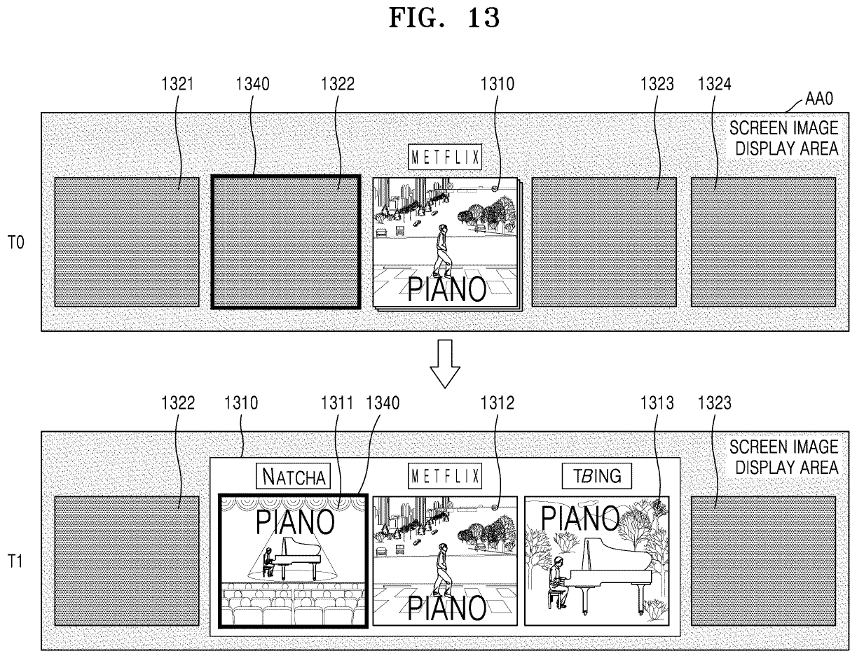

As such, when it is determined that the display of the item group needs to be changed during a process of moving a focus, methods of changing the display of the item group may be provided based on whether all of the content items constituting the item group need to be displayed at one time and whether the content items constituting the item group are changeable to a single item, thereby controlling the display of the item group within a range in which the distinctiveness of the item group is maintained. Various methods of displaying an item group will now be described with reference to FIGS. 13 through 19. FIGS. 13 through 16 illustrate an example of applying a visual effect by displaying a focus on a content item.

FIG. 13 is a reference diagram for explaining a method of displaying a focus on an item group, according to an embodiment. FIG. 13 illustrates an example in which a display method of an item group changes according to whether a focus is displayed on the item group.

Referring to FIG. 13, according to an embodiment of the disclosure, first, second, and third content items 1311, 1312, and 1313 constituting an item group 1310 may be displayed as a plurality of thumbnail images independent from each other. The first, second, and third content items 1311, 1312, and 1313 may connect to different content providing servers, and may provide the same content provided by the different content providing servers.

According to an embodiment of the disclosure, when a focus 1340 is displayed on a content item other than the item group 1310 (or on a content item not set as a group), the electronic device 100 may display the content items constituting the item group 1310 in an overlapping manner. When moving the focus 1340 to any of the content items constituting the item group 1310, the electronic device 100 may display the content items constituting the item group 1310 in a non-overlapping manner (or in an expanded manner).

For example, at a time point TO, the one item group 1310 including first, second, and third content items 1311, 1312, and 1313, first and second adjacent content items 1321 and 1322 positioned adjacent to a left side of the item group 1310, and third and fourth adjacent content items 1323 and 1324 positioned adjacent to the right side of the item group 1310 may be displayed on a user interface screen AA0. At the time point TO, a focus may be displayed on the second adjacent content item 1340 not set as a group, and the first, second, and third content items 1311, 1312, and 1313 constituting the item group 1310 may be overlapped and displayed. According to an embodiment of the disclosure, a topmost content item among the first, second, and third content items 1311, 1312, and 1313 displayed to overlap each other may be determined alternately.

For example, thereafter, at a time point T1, the focus 1340 may be moved to the item group 1310, and the first, second, and third content items 1311, 1312, and 1313 constituting the item group 1310 may be displayed without overlapping each other (or in an expanded manner). The first, second, and third content items 1311, 1312, and 1313 may be arranged horizontally side by side. In response to an input of moving the focus 1340 from the second adjacent content item 1322 to the right, the electronic device 100 may display the focus 1340 on the first content item 1311 that is closest to the second adjacent content item 1322. When the focus 1340 is initially displayed on the first content item 1311 among the first, second, and third content items 1311, 1312, and 1313 of the item group 1310, a content providing server having a highest accessibility may be connected to the first content item 1311. The content providing server having a highest accessibility may be determined based on accessibility information, and the accessibility information may include at least one of whether content providing servers are logged in, whether the content providing servers are subscribed, or the frequency of use of the content providing servers. Accordingly, a focus may be allowed to be first displayed on a content item connected to the content providing server with the highest accessibility, so that the user may easily select content provided by a desired content providing server, leading to an increase in the convenience of the user's focus manipulation.

Although not shown in the drawings, when receiving an input of moving the focus 1340 from the third adjacent content item 1323 to the left, the electronic device 100 may display the focus 1340 on the third content item 1313 that is closest to the third adjacent content item 1323. When the focus 1340 is initially displayed on the third content item 1313 among the first, second, and third content items 1311, 1312, and 1313 of the item group 1310, a content providing server having a highest accessibility may be connected to the third content item 1313 for convenience of the user.

Thereafter, at the time point T1, because the first, second, and third content items 1311, 1312, and 1313 constituting the item group 1310 are displayed in a non-overlapping manner, some of adjacent content items positioned adjacent to the item group 1310 may disappear from the user interface screen AA0. For example, at the time point T1, the electronic device 100 may cause the first adjacent content item 1321 and the fourth adjacent content item 1322 to disappear from the user interface screen AA0.

FIG. 13 illustrates an example of applying a visual effect by displaying a focus on a content item, but the visual effect applied to the content item is not limited to that illustrated in FIG. 13. When a visual effect is applied to a content item other than an item group, the electronic device 100 may overlap and display a plurality of content items constituting the item group. When a visual effect is applied to any of the plurality of content items constituting the item group, the electronic device 100 may display the plurality of content items constituting the item group in a non-overlapping manner (or in an expanded manner).

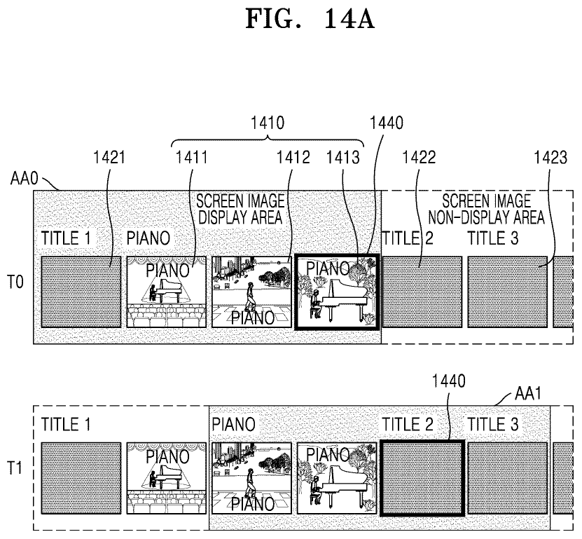

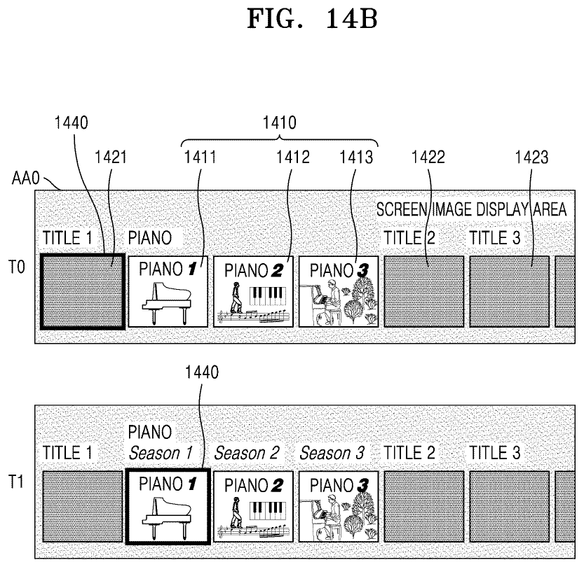

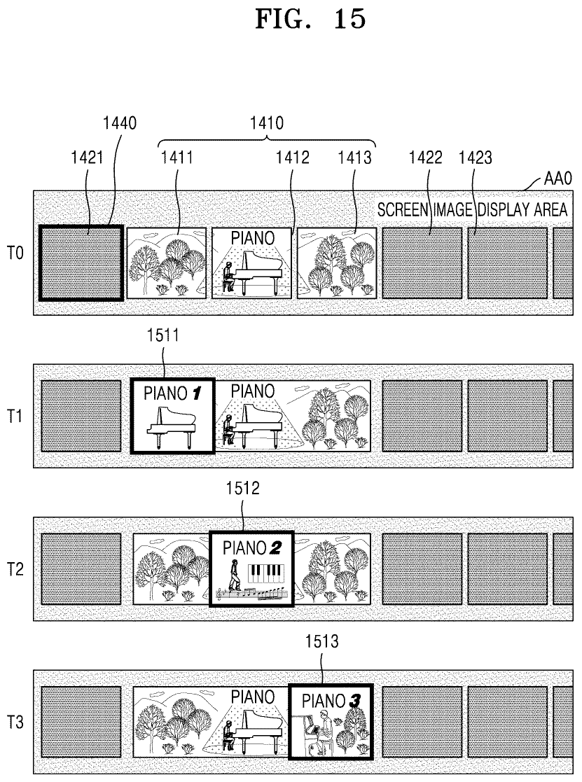

FIGS. 14A and 14B are reference diagrams for explaining a method of displaying text regarding an item group when moving a focus, according to an embodiment. FIG. 15 is a reference diagram for explaining a method of displaying an image of an item group when moving a focus, according to an embodiment. Referring to FIGS. 14A through 15, according to an embodiment of the disclosure, when a user input of moving a visual effect is received, the electronic device 1000 may change at least one of an image displaying a plurality of content items or a display of text regarding an item group. FIGS. 14A through 15 illustrate an example of applying a visual effect by displaying a focus on a content item. For example, when a focus 1440 moves from an item group 1410 to an adjacent next content item or moves within the item group 1410, the electronic device 100 may change at least one of an image representing content items constituting the item group 1410 or a display of text regarding the item group 1410.

Referring to FIG. 14A, according to an embodiment of the disclosure, on the item group 1410 or content items 1421, 1422, and 1423 not set as a group, text related to content provided in correspondence with the item group 1410 or content items 1421, 1422, and 1423 may be displayed. For example, the text may include the title of content provided by each content item. When the focus 1440 moves from the item group 1410 to a next adjacent content item, electronic device 100 may change the location of text regarding the item group 1410.

For example, the focus 1140 is displayed on a third content item 1113 positioned on an edge of a user interface screen AA0 at a time point TO, and thus the focus 1140 needs to move to a next content item not displayed on the user interface screen AA0 according to an input of moving the focus 1440, so that an area of a scrolling list displayed within the user interface screen AA0 may be changed. When changing the area of thea scrolling list displayed within the user interface screen AA0, the electronic device 100 may display only content items (e.g., second and third content items 1412 and 1413) of the item group 1410 excluding some content items (e.g., the first content item 1411) needing to deviate from the screen, within the user interface screen AA0. When text associated with the item group 1410 is displayed on some content items needing to deviate from the screen (e.g., the first content item 1411), and the area of the scrolling list displayed within the user interface screen AA0 is changed, the electronic device 100 may change the location of the text associated with the item group 1410 to be on the content items remaining within a user interface screen AA1 (e.g., the second and third content items 1412 and 1413). When display of the item group changes, text regarding the item group may be left within a user interface screen, so that, even when only a portion of the item group is displayed or the item group is displayed as a single item, a user may easily ascertain information about the item group through text.

Referring to FIG. 14B, according to an embodiment of the disclosure, on the item group 1410 or content items 1421, 1422, and 1423 not set as a group, text related to content provided in correspondence with the item group 1410 or content items 1421, 1422, and 1423 may be displayed. For example, the text may include the title of content provided by each content item.

According to an embodiment of the disclosure, the first, second, and third content items 1411, 1412, and 1413 constituting the item group 1410 may correspond to different content access information, respectively. For example, the first, second, and third content items 1411, 1412, and 1413 constituting the item group 1410 may connect to the same content providing server, and provide mutually-related pieces of content provided by the same content providing server, as illustrated in FIG. 6A. For example, the first, second, and third content items 1411, 1412, and 1413 constituting the item group 1410 may connect to different content providing servers, and provide the same content provided by the different content providing servers, as illustrated in FIG. 6C.

According to an embodiment of the disclosure, when the focus 1440 moves from an adjacent previous content item (e.g., the first adjacent content item 1421) to the item group 1410, the electronic device 100 may change the contents of the text regarding the item group 1410. For example, when the focus 1440 is displayed on the item group 1410, the electronic device 100 may further display text regarding each of the first, second, and third content items 1411, 1412, and 1413 constituting the item group 1410. The further text regarding each of the first, second, and third content items 1411, 1412, and 1413 may include information regarding to which series content provided by each content item corresponds, to which season the content provided by each content item corresponds, and via which content providing server content is provided by each content item. When a focus is displayed within an item group, text including identification information about each content item is additionally displayed, so that a user may easily ascertain information about each content item through the text and easily select a desired content item.

Referring to FIG. 15, according to an embodiment of the disclosure, when the focus 1440 moves from the item group 1410 to an adjacent next content item or moves within the item group 1410, the electronic device 100 may change an image of at least one of the content items constituting the item group 1410.

According to an embodiment of the disclosure, the electronic device 100 may independently display the focus 1440 on each of the first, second, and third content items 1411, 1412, and 1413 constituting the item group 1410.

According to an embodiment of the disclosure, the first, second, and third content items 1411, 1412, and 1413 constituting the item group 1410 may correspond to different pieces of content access information, respectively. For example, the first, second, and third content items 1411, 1412, and 1413 constituting the item group 1410 may connect to the same content providing server, and provide mutually-related pieces of content provided by the same content providing server, as illustrated in FIG. 6A. For example, the first, second, and third content items 1411, 1412, and 1413 constituting the item group 1410 may connect to different content providing servers, and provide the same content provided by the different content providing servers, as illustrated in FIG. 6C.

According to an embodiment of the disclosure, when the focus 1440 moves from an adjacent previous content item (e.g., the first adjacent content item 1421) to the item group 1410, the electronic device 100 may change an image of a content item on which a focus is displayed (e.g., the first content item 1411) among the first, second, and third content items 1411, 1412, and 1413 constituting the item group 1410. According to an embodiment of the disclosure, when the focus 1440 moves within the item group 1410, the electronic device 100 may change an image of a previously focused content item among the first to third content items 1411, 1412, and 1413 constituting the item group 1410 to the original image, and change images of newly focused content items 1511, 1512, and 1513. For example, the electronic device 100 may change the newly focused content items 1511, 1512, and 1513 to images from which content desired to be provided may be ascertained in more detail. For example, the electronic device 100 may change images of the newly focused content items 1511, 1512, and 1513 to images with additional descriptions from which content desired to be provided may be ascertained in more detail. When a focus is displayed within an item group, the electronic device 100 may change a focused content item among the content items displayed as a single thumbnail image to an image including identification information about content corresponding to the focused content item, so that a user may easily ascertain information about each content item through the changed image and easily select a desired content item.

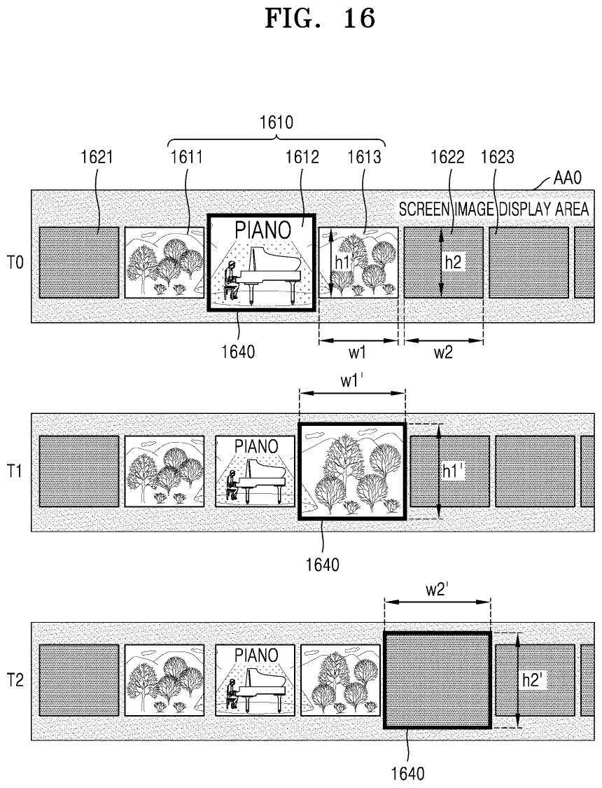

FIG. 16 is a reference diagram for explaining a method of displaying an item group when moving a focus, according to an embodiment. FIG. 16 illustrates an example in which a content item on which a focus is displayed changes in size.

Referring to FIG. 16, according to an embodiment of the disclosure, a user interface screen AA0 may display a portion of a scrolling list, wherein the scrolling list may include an item group 1610 including at least a plurality of content items. FIG. 16 illustrates that an item group 1610 including first, second, and third content items 1611, 1612, and 1613, a first adjacent content item 1621 positioned adjacent to the left side of the item group 1610, and second and third adjacent content items 1622 and 1623 positioned adjacent to the right side of the item group 1610 are displayed on the user interface screen AA0.

According to an embodiment of the disclosure, the electronic device 100 may change the size of a content item on which a focus 1640 is displayed, and may display the content item with a changed size. For example, at a time point TO, the electronic device 100 may display the focus 1640 on the second content item 1612, and the second content item 1612 on which the focus 1640 is displayed may be displayed larger than the other content items (e.g., the first and third content items 1611 and 1613 and the first, second, and third adjacent content items 1621, 1622, and 1623). Thereafter, at a time point T1, the electronic device 100 may display the focus 1640 on the third content item 1613 according to an input of moving the focus 1640 to the right, and the third content item 1613 may be displayed larger than the other content items (e.g., the first and second content items 1611 and 1612 and the first, second, and third adjacent content items 1621, 1622, and 1623). At the same time, the second content item 1612 on which the focus 1640 is displayed at the time point TO, which is an immediately previous time point, may be reduced to its original size when the focus 1640 is not displayed. At the time point T1, a width w1′ and height h1′ of the third content item 1613 may be increased larger than a width w1 and height h1 of the third content item 1613 at the time point TO, which is an immediately preceding time point, and thus the third content item 1613 with the width w1′ and the height h1′ may be displayed. However, embodiments are not limited thereto, and only one of a width and height of a content item may be increased, and thus a content item with the increased width or height may be displayed.

For example, thereafter, at a time point T2, the electronic device 100 may display the focus 1640 on the second adjacent content item 1622 according to an input of moving the focus 1640 to the right, and the second adjacent content item 1622 may be displayed larger than the other content items (e.g., the first through third content items 1611 through 1613 and the first and third adjacent content items 1621 and 1623). At the same time, the third content item 1613 on which the focus 1640 is displayed at the time point T1, which is an immediately preceding time point, may be reduced to its original size when the focus 1640 is not displayed. At the time point T2, a width w2′ and height h2′ of the second adjacent content item 1622 may be increased larger than a width w2 and height h2 of the second adjacent content item 1622 at the time point T1, which is an immediately preceding time point, and thus the second adjacent content item 1622 with the width w2′ and the height h2′ may be displayed. However, embodiments are not limited thereto, and only one of a width and height of a content item may be increased, and thus a content item with the increased width or height may be displayed. As such, by enlarging the size of a content item that is focused to be larger than the other content items, the content item that is focused may be visually emphasized, allowing the user to easily check which content item is in focus.

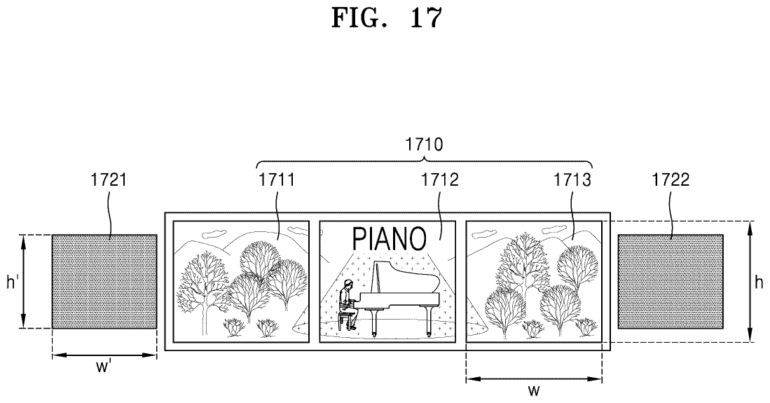

FIG. 17 illustrates an example of an item group displayed within a user interface, according to an embodiment. FIG. 17 illustrates an example in which content items are provided in different sizes.

Referring to FIG. 17, a user interface screen may display a portion of a scrolling list, wherein the scrolling list may include an item group 1710 including at least a plurality of content items. FIG. 17 illustrates that an item group 1710 including first, second, and third content items 1711, 1712, and 1713, a first adjacent content item 1721 positioned adjacent to the left side of the item group 1710, and second and third adjacent content items 1722 and 1723 positioned adjacent to the right side of the item group 1710 are displayed on the user interface screen AA0.

According to an embodiment of the disclosure, content items may be displayed as images of different sizes, regardless of whether they are in focus. For example, the first, second, and third content items 1711, 1712, and 1713 constituting the item group 1710 and the first and second adjacent content items 1721 and 1722 not set as a group may be displayed as images of different sizes. Respective widths w and respective heights h of the images as which the first, second, and third content items 1711, 1712, and 1713 constituting the item group 1710 are displayed may be increased larger than respective widths w′ and respective heights h′ of the images as which the first and second adjacent content items 1721 and 1722 are displayed, and thus the first, second, and third content items 1711, 1712, and 1713 with the larger widths w and heights h may be displayed. However, FIG. 17 illustrates a relationship between content items, and embodiments are not limited thereto. As such, by providing a larger size for a content item desired to be emphasized than the other content items, a content item with high importance may be visually emphasized so that a user may easily access the content item with high importance, or a content item desired to be advertised may be visually emphasized so that an advertising effect may be enhanced.

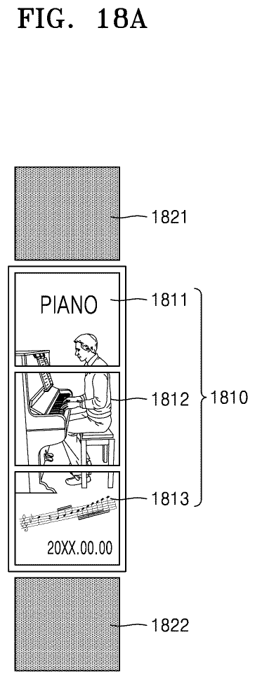

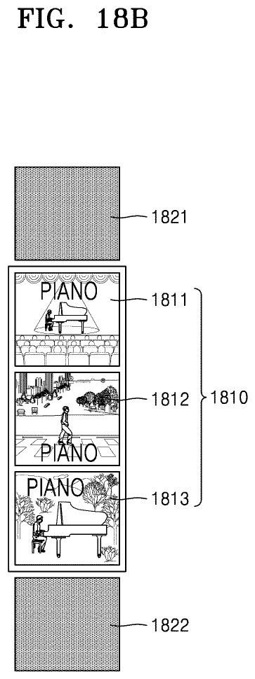

FIGS. 18A and 18B illustrate examples of an item group displayed within a user interface, according to an embodiment.

Referring to FIGS. 18A and 18B, according to an embodiment of the disclosure, content items may be arranged to be scrollable in a vertical direction. An item group 1810 and adjacent content items 1821 and 1822 may be arranged vertically, and first, second, and third content items 1811, 1812, and 1813 constituting the item group 1810 may also be arranged vertically.

Referring to FIG. 18A, according to an embodiment of the disclosure, the first, second, and third content items 1811, 1812, and 1813 constituting the item group 1810 may be displayed as a single thumbnail image. The first, second, and third content items 1811, 1812, and 1813 may be displayed as a plurality of images into which the single thumbnail image is split in accordance with the number of content items according to tile sizes on which the first, second, and third content items 1811, 1812, and 1813 are to be displayed.

Referring to FIG. 18B, according to an embodiment of the disclosure, the first, second, and third content items 1811, 1812, and 1813 constituting the item group 1810 may be displayed as a plurality of thumbnail images independent from each other.

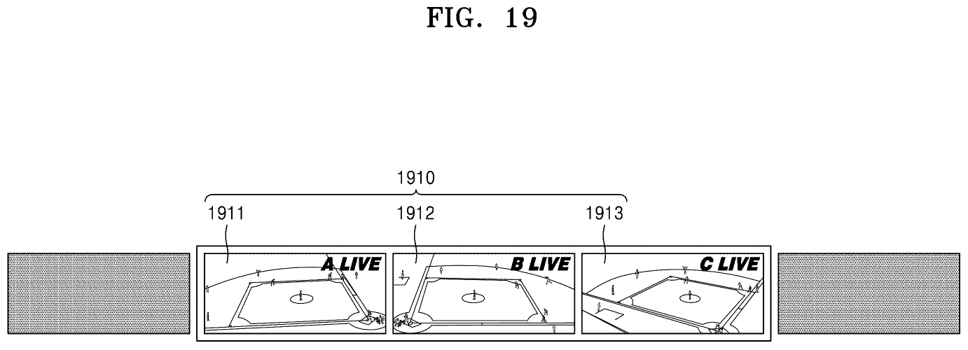

FIG. 19 illustrates an example of an item group displayed within a user interface, according to an embodiment.

Referring to FIG. 19, according to an embodiment of the disclosure, first, second, and third content items 1911, 1912, and 1913 constituting an item group 1910 may provide pieces of broadcasting content. The first, second, and third content items 1911, 1912, and 1913 may provide broadcast content transmitted by different broadcasters or different OTT service providers, but may provide the same broadcast content. For example, the first, second, and third content items 1911, 1912, and 1913 may provide broadcast content for the same sports game (e.g., a World Cup game) broadcasted by different broadcasters or different OTT service providers. For example, the first, second, and third content items 1911, 1912, and 1913 may provide pieces of real-time presidential speech broadcast content transmitted by different broadcasters. As such, the electronic device 100 may group and display content items corresponding to real-time broadcast content provided by a plurality of broadcasters or a plurality of OTT service providers, so that a user may easily check, at a glance, and select real-time broadcast content from a desired broadcaster or a desired OTT service provider.

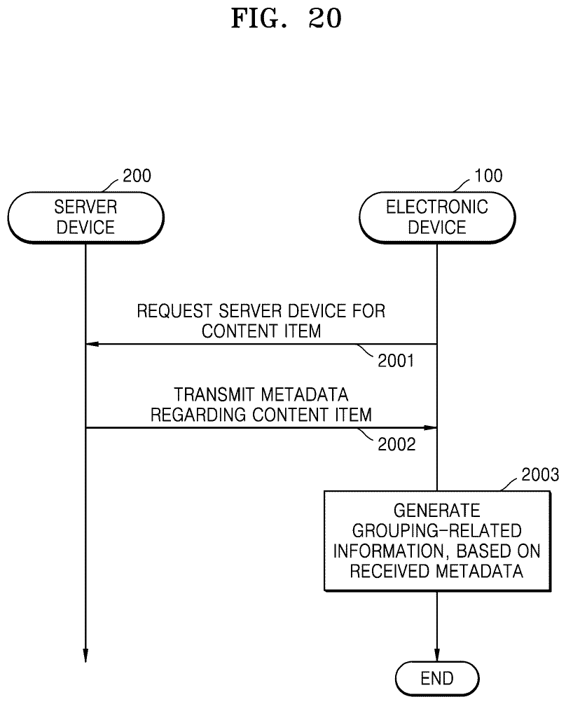

FIG. 20 is a flowchart of a method, performed by the electronic device 100, of receiving metadata regarding a content item from the server device 200, according to an embodiment.

Referring to FIG. 20, in operation 2001, the electronic device 100 may request the server device 200 for a content item. The electronic device 100 may also request the server device 200 for a format of information about the content item desired to be received. For example, the electronic device 100 may request for information about content desired to be provided through the content item and information about how to display the content item.

In operation 2002, the server device 200 may transmit metadata regarding the content item, in response to a content item request from the electronic device 100. The server device 200 may generate and transmit the metadata according to the format requested by the electronic device 100. According to an embodiment of the disclosure, the metadata generated by the server device 200 may include information about content desired to be provided through each content item and information about how to display the content item. The metadata generated by server device 200 may not include grouping-related information regarding an item group including a plurality of content items.

In operation 2003, the electronic device 100 may generate the grouping-related information, based on the received metadata. The electronic device 100 may generate at least one item group by grouping content items that provide the same content or by grouping content items that provide mutually related pieces of content, based on the generated metadata. The electronic device 100 may generate grouping-related information including a method of displaying an item group, based on metadata about each content item set as a group.

For example, a case where the electronic device 100 receives content items corresponding to the same content from a plurality of content providers, respectively, may be considered. The content items provided by each of the content providers may not include grouping-related information. In order to effectively manage a plurality of content items for the same content, provided by a plurality of different content providers, the electronic device 100 may group the plurality of content items into one item group and display the item group. The electronic device 100 may use an item group display method or item group control method disclosed in the disclosure, in order to manage the plurality of content items provided by from the plurality of different content providers.

An operation method of an electronic device according to an embodiment may include an operation of controlling provision of a user interface including a plurality of content items, each corresponding to each content access information.

The operation method of an electronic device according to an embodiment may include an operation of controlling a visual effect to be applied collectively to an item group including the plurality of content items to enable the plurality of content items to be collectively selectable, based on pieces of the content access information of the plurality of content items being identical to each other.

The operation method of an electronic device according to an embodiment may include an operation of controlling a visual effect to be applied individually to each of the plurality of content items, respectively, to enable the plurality of content items to be individually selectable, based on the pieces of the content access information of the plurality of content items being different from each other.

In the operation method of an electronic device according to an embodiment of the disclosure, the plurality of content items included in the user interface may correspond, respectively, to a plurality of different servers providing the same content.

The operation method of an electronic device according to an embodiment may include an operation of, in response to a user input corresponding to selection of one of the plurality of content items included in the user interface, controlling a communication interface to receive content corresponding to a content item based on the user input from a server corresponding to the content item based on the user input.

The operation method of an electronic device according to an embodiment may include an operation of controlling provision of the user interface in which the plurality of content items are arranged, based on accessibility information for the plurality of different servers. According to the operation method of an electronic device according to an embodiment of the disclosure, the accessibility information may include at least one of whether an account of a service provided by each of the plurality of different servers is logged in, whether the service is subscribed, or a frequency of use of the service.

The operation method of an electronic device according to an embodiment may include an operation of controlling provision of the user interface in which the plurality of content items are displayed as a single thumbnail image. According to the operation method of an electronic device according to an embodiment of the disclosure, the single thumbnail image may correspond to any one of a pre-determined image, an image automatically generated based on AI, or an image received from any one of the plurality of different servers.

The operation method of an electronic device according to an embodiment may include an operation of controlling the communication interface to receive grouping-related information from a server that provides content corresponding to the plurality of content items. According to the operation method of an electronic device according to an embodiment of the disclosure, the grouping-related information may include at least one of the arrangement order of the plurality of content items constituting the item group, whether the plurality of content items are displayable independently, or whether the plurality of content items are changeable into a single content item.

In the operation method of an electronic device according to an embodiment of the disclosure, in response to a user input corresponding to movement of the visual effect guiding that a content item is selectable, the electronic device may control display of the item group, based on at least one of whether the plurality of content items constituting the item group are independently displayable or whether the plurality of content items are changeable into the single content item.

The operation method of an electronic device according to an embodiment may include an operation of, based on independent display of the plurality of content items being unsupported and change of the plurality of content items into a single content item being enabled, changing the plurality of content items constituting the item group into the single content item in response to a user input of moving the visual effect from the item group to an adjacent content item.

The operation method of an electronic device according to an embodiment may include an operation of, based on independent display of the plurality of content items being unsupported and the plurality of content items into a single content item being unchangeable, controlling the item group to disappear or changing the plurality of content items into the single content item displayed as a thumbnail image related to the item group, in response to a user input of moving the visual effect from the item group to an adjacent content item.

The operation method of an electronic device according to an embodiment may include an operation of controlling the plurality of content items constituting the item group to be overlapped and displayed, based on the visual effect being applied to content items other than the item group.

The operation method of an electronic device according to an embodiment may include an operation of controlling the plurality of content items constituting the item group to be displayed without overlapping each other, based on the visual effect being applied to one of the plurality of content items constituting the item group.

Embodiments of the disclosure can also be embodied as a storage medium including instructions executable by a computer such as a program module executed by the computer. A computer readable medium can be any available medium which can be accessed by the computer and includes all volatile/non-volatile and removable/non-removable media. Further, the computer readable medium may include all of a computer storage medium and a communication medium. The computer storage medium includes all volatile/non-volatile and removable/non-removable media embodied by a certain method or technology for storing information such as computer readable instruction code, a data structure, a program module or other data. Communication media may typically include computer readable instructions, data structures, or other data in a modulated data signal, such as program modules.

In addition, computer-readable storage media may be provided in the form of non-transitory storage media. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

According to an embodiment of the disclosure, methods according to various disclosed embodiments may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as a memory of a manufacturer's server, a server of an application store, or a relay server, or may be temporarily generated.

While the disclosure has been particularly shown and described with reference to exemplary embodiments thereof, it will be understood that various changes in form and details may be made therein without departing from the spirit and scope of the disclosure. Thus, the above-described embodiments should be considered in descriptive sense only and not for purposes of limitation. For example, each component described as a single type may be implemented in a distributed manner, and similarly, components described as being distributed may be implemented in a combined form.

The scope of the disclosure is indicated by the scope of the claims to be described later rather than the above detailed description, and all changes or modified forms derived from the meaning and scope of the claims and the concept of equivalents thereof should be interpreted as being included in the scope of the disclosure.

1. An electronic device comprising:
at least one processor including a processing circuit; and
a memory storing a plurality of instructions executable by the at least one processor,
wherein the at least one processor individually or collectively executes the plurality of instructions to cause the electronic device to:
control provision of a user interface including a plurality of content items, each corresponding to content access information;
control a visual effect to be applied collectively to an item group including the plurality of content items to enable the plurality of content items to be collectively selectable, based on pieces of the content access information of the plurality of content items being identical to each other; and
control the visual effect to be applied individually to the plurality of content items, respectively, to enable the plurality of content items to be individually selectable, based on the pieces of the content access information of the plurality of content items being different from each other.

2. The electronic device of claim 1, wherein the electronic device further comprises:
a communication interface; wherein
the plurality of content items included in the user interface correspond to a plurality of different servers providing same content, respectively, and
the at least one processor individually or collectively executes the instructions to cause the electronic device to, in response to a user input corresponding to selection of one of the plurality of content items included in the user interface, control the communication interface to receive content corresponding to a content item based on the user input, from a server corresponding to the content item based on the user input.

3. The electronic device of claim 2, wherein
the at least one processor individually or collectively executes the instructions to cause the electronic device to control provision of the user interface in which the plurality of content items are arranged, based on accessibility information for the plurality of different servers, and
the accessibility information includes at least one of whether an account of a service provided by each of the plurality of different servers is logged into, whether the service is subscribed to, or a frequency of use of the service.

4. The electronic device of claim 2, wherein
the at least one processor individually or collectively executes the instructions to cause the electronic device to control provision of the user interface in which the plurality of content items are displayed as a single thumbnail image, and
the single thumbnail image corresponds to any one of a pre-determined image, an image automatically generated based on artificial intelligence (AI), or an image received from any one of the plurality of different servers.

5. The electronic device of claim 1, wherein
the at least one processor individually or collectively executes the instructions to cause the electronic device to control a communication interface to receive grouping-related information from a server that provides content corresponding to the plurality of content items, and
the grouping-related information includes at least one of an arrangement order of the plurality of content items constituting the item group, whether the plurality of content items are displayable independently, or whether the plurality of content items are changeable into a single content item.

6. The electronic device of claim 5, wherein the at least one processor individually or collectively executes the instructions to cause the electronic device, in response to a user input corresponding to movement of the visual effect guiding that guiding that a content item is selectable, to control display of the item group, based on at least one of whether the plurality of content items constituting the item group are independently displayable or whether the plurality of content items are changeable into the single content item.

7. The electronic device of claim 6, wherein, based on independent display of the plurality of content items being unsupported and the plurality of content items into a single content item being unchangeable, the at least one processor individually or collectively executes the instructions to cause the electronic device to change the plurality of content items constituting the item group into the single content item, in response to a user input of moving the visual effect from the item group to an adjacent content item.

8. The electronic device of claim 6, wherein, based on independent display of the plurality of content items being unsupported and the plurality of content items into a single thumbnail item being unchangeable, the at least one processor individually or collectively executes the instructions to cause the electronic device to control the item group to disappear or change the plurality of content items into the single content item displayed as a thumbnail image related to the item group, in response to a user input of moving the visual effect from the item group to an adjacent content item.

9. The electronic device of claim 1, wherein the at least one processor individually or collectively executes the instructions to cause the electronic device to:
control the plurality of content items constituting the item group to overlap each other and be displayed, based on the visual effect being applied to content items other than the item group; and
control the plurality of content items constituting the item group to be displayed without overlapping each other, based on the visual effect being applied to one of the plurality of content items constituting the item group.

10. The electronic device of claim 1, wherein the at least one processor individually or collectively executes the instructions to cause the electronic device to change at least one of an image displaying the plurality of content items or a display of text regarding the item group, in response to a user input of moving the visual effect.

11. A method of operating an electronic device, the method comprising:
controlling provision of a user interface including a plurality of content items, each corresponding to content access information;
controlling a visual effect to be applied collectively to an item group including the plurality of content items to enable the plurality of content items to be collectively selectable, based on pieces of the content access information of the plurality of content items being identical to each other; and
controlling the visual effect to be applied individually to the plurality of content items, respectively, to enable the plurality of content items to be individually selectable, based on the respective pieces of the content access information of the plurality of content items being different from each other.

12. The method of claim 11, wherein
the plurality of content items included in the user interface correspond, respectively, to a plurality of different servers providing same content, and
in response to a user input corresponding to selection of one of the plurality of content items included in the user interface, controlling a communication interface included in the electronic device to receive content corresponding to a content item based on the user input, from a server corresponding to the content item based on the user input.

13. The method of claim 12, further comprising:
controlling provision of the user interface in which the plurality of content items are arranged, based on accessibility information for the plurality of different servers,
wherein the accessibility information includes at least one of whether an account of a service provided by each of the plurality of different servers is logged into, whether the service is subscribed to, or a frequency of use of the service.

14. The method of claim 12, further comprising:
controlling provision of the user interface in which the plurality of content items are displayed as a single thumbnail image,
wherein the single thumbnail image corresponds to any one of a pre-determined image, an image automatically generated based on artificial intelligence (AI), or an image received from any one of the plurality of different servers.

15. The method of claim 11, further comprising:
controlling the communication interface included in the electronic device to receive grouping-related information from a server that provides content corresponding to the plurality of content items,
wherein the grouping-related information includes at least one of an arrangement order of the plurality of content items constituting the item group, whether the plurality of content items are displayable independently, or whether the plurality of content items are changeable into a single content item.

16. The method of claim 15, further comprising, in response to a user input corresponding to movement of the visual effect guiding that a content item is selectable, controlling display of the item group, based on at least one of whether the plurality of content items constituting the item group are independently displayable or whether the plurality of content items are changeable into the single content item.

17. The method of claim 16, further comprising:
controlling of the display of the item group, based on at least one of whether the plurality of content items constituting the item group are independently displayable or whether the plurality of content items are changeable into a single content item, based on independent display of the plurality of content items being unsupported and change of the plurality of content items into a single content item being enabled, changing the plurality of content items constituting the item group into the single content item in response to a user input of moving the visual effect from the item group to an adjacent content item.

18. The method of claim 16, further comprising:
controlling of the display of the item group, based on at least one of whether the plurality of content items constituting the item group are independently displayable or whether the plurality of content items are changeable into a single content item, based on independent display of the plurality of content items being unsupported and the plurality of content items into a single content item being unchangeable, controlling the item group to disappear or changing the plurality of content items into the single content item displayed as a thumbnail image related to the item group, in response to a user input of moving the visual effect from the item group to an adjacent content item.

19. The method of claim 11, further comprising:
controlling the plurality of content items constituting the item group to be overlapped and displayed, based on the visual effect being applied to content items other than the item group; and
controlling the plurality of content items constituting the item group to be displayed without overlapping each other, based on the visual effect being applied to one of the plurality of content items constituting the item group.

20. A non-transitory computer-readable recording medium having recorded thereon a computer program, which, is executable by a computer, to perform the method comprising:
controlling provision of a user interface including a plurality of content items, each corresponding to content access information;
controlling a visual effect to be applied collectively to an item group including the plurality of content items to enable the plurality of content items to be collectively selectable, based on pieces of the content access information of the plurality of content items being identical to each other; and
controlling the visual effect to be applied individually to the plurality of content items, respectively, to enable the plurality of content items to be individually selectable, based on the pieces of the content access information of the plurality of content items being different from each other.
